(19) United States
(12) Patent Application Publication
(10) Pub. No.: US 2013/0126042 A1
(43) Pub. Date: May 23, 2013

(54) APPARATUS FOR DISPENSING AND/OR VENDING A BULK PRODUCT AND IMPROVEMENTS THEREIN

(71) Applicants: Brian Dale DEWALD, Calgary (CA); Joshua Bruce LITTLEJOHN, Calgary (CA); Christopher Roy LOCK, Calgary (CA); Graham Russell NELSON, Calgary (CA)

(72) Inventors: Brian Dale DEWALD, Calgary (CA); Joshua Bruce LITTLEJOHN, Calgary (CA); Christopher Roy LOCK, Calgary (CA); Graham Russell NELSON, Calgary (CA)

(21) Appl. No.: 13/301,325

(22) Filed: Nov. 21, 2011

(51) Int. Cl. B65B 3/04; B67D 7/78

(52) U.S. Cl. 141/105; 222/134; 222/1

(57) ABSTRACT

An apparatus for dispensing and/or vending a bulk product. The apparatus comprises one or more bins for holding a bulk product, a dispensing mechanism operatively coupled to each of the bins, a controller operatively coupled to the dispensing mechanisms, and an interface for receiving a request for one of the bulk products. The controller is operatively coupled to the interface and configured to generate one or more control signals in response to a request for controlling the dispensing mechanism to dispense one of the bulk products.

### FIELD OF THE INVENTION

The present invention relates to vending and dispensing equipment, and more particularly, to vending/dispensing apparatus for bulk products where the quantity of the product to be dispensed is specified by a customer at the time of purchase or selection.

### BACKGROUND OF THE INVENTION

Purchasing products in bulk form has become an acceptable type of purchase by consumers. This is evidenced by the range of bulk products offered for sale in a variety of settings, such as for example, grocery stores, coffee stores, pet food stores and candy stores.

Bulk purchases of a product are made either by weighing the product, which is taken from a storage bin, or by buying a package containing a predetermined amount of bulk product, in food stores or the bulk food section of grocery stores. The purchase is completed with a cashier using a cash register. It will be appreciated that this limits the locations and times when a product can be purchased in bulk, which in turn can present a convenience obstacle for the consumer.

In the case of candy manufacturers, when a product is sold in pre-packaged form labeled with the manufacturer's brand, it is distributed by the manufacturer mainly through point-of-sale outlets. Many candy manufacturers can also supply product in bulk, but are typically limited to selling predetermined quantities of bulk product because of distribution and packaging considerations. For example, candies can be purchased three different ways: in pre-packaged form under the manufacturer label, in bulk form from a vending machine, or in bulk form from an open bin in a grocery store or bulk food store.

In many cases the bulk bins used to store the products offered are susceptible to contamination, shrinkage and spilling, which can be further exacerbated by consumers reaching into the bin with their hands to gather or sample the product before purchase. It is conceivable that the vendor may be put at risk or incur liability. Furthermore, even where recently available bulk gravity bins have been implemented to ensure sanitation, the dispensing mechanisms are not able to dispense products in measured quantities.

Where dry bulk products are acquired in larger quantities there is typically a need to employ staff to measure, weigh, and determine a final or sale price and collect money from the customer. The overhead cost associated with supplying the equipment and employing staff is significantly more than if the acquisition process was an unmanned automated process.

In most cases where bulk products are sold, the customer must “guess” the weight and the corresponding cost of the purchase which may or may not be close to the weight the customer actually desires or the amount of money the customers actually wants to spend on the purchase. Even in cases where weigh scales are available in the store, the customer must perform the iterative task of dispensing, weighing, adding or removing product, re-weighing, etc. until the desired amount of product or cost is determined.

In the case where products are sold through automated bulk vending equipment, the vendor is limited to selling product using a fixed price and a smaller, fixed vend quantity. The customer typically inserts a coin (token or paper currency) and a fixed quantity is dispensed. Currently available automated equipment therefore does not allow the customer to specify the amount of product desired, e.g. based on weight, product count or value. In addition, automated vending equipment is limited to dispensing only uniform products that are hard-coated and not subject to “sticking” together because of warm or humid conditions.

In summary, the sale of bulk foods tends to be costly, restrictive and not customer friendly in large part due to limitations of known bulk storage and dispensing technology. Accordingly, there remains a need for improvements in the art.

### BRIEF SUMMARY OF THE INVENTION

The present invention comprises a vending system, and components thereof, and a method for dispensing and/or vending a product stored in bulk, wherein the quantity of the product is specified or determined by a consumer according to weight and/or dollar value.

According to an embodiment, there is provided system for dispensing a bulk product, the system comprises one or more bins, each for holding a bulk product, a control panel for receiving a user request for one of the bulk products; a computer operatively coupled to the control panel and a control board operatively coupled to the computer; the control board being operatively coupled to the computer and being configured to be responsive to control commands; the control board being operatively coupled to the one or more bins, and responsive to the control commands for controlling a dispensing component coupled to each of the one or bins to dispense the requested bulk product from the associated bin in an amount based on the user request.

According to another embodiment, there is provided an apparatus for dispensing one or more bulk products, the bulk products being contained in one or more bins, each of the bins including a dispensing mechanism and the dispensing mechanism being operatively coupled to a controller, the apparatus comprises: an interface configured for receiving a user request for one of the bulk products and generating one or more signals representative of the user request; a control unit operatively coupled to the interface for receiving the one or more representative signals, and the control unit being configured for generating one or more controls signals based on the one or more representative signals; the control unit including an interface for operatively coupling to the one or more actuators and being configured for sending one or more control signals to the one or more of the actuators; and the one or more actuators being responsive to the one or more control signals to dispense the bulk product from the bin based on the user request.

According to another embodiment, there is provided a bin for holding a bulk product and suitable for use with a dispensing apparatus, the bin comprises: a housing; an internal bin scoop; an actuator for moving the bin scoop between a product loading position and a product dispensing position and an agitation mechanism for agitating product contained in the bin.

According to another embodiment, there is provided a cup dropper module for a vending kiosk comprising a plurality of bins and each of the bins holding a product, the cup dropper module comprises: a plurality of auger units, each of the auger units being configured to hold a plurality of cups; an auger motor operatively coupled to each of the auger units and configured to actuate the auger unit to individually release the plurality of cups; a funnel operatively connected to the plurality of bins and configured to receive a product from each the plurality of bins, and the funnel including a downspout configured for directing the received product into one of the cups; a conveyor operatively coupled to a conveyer drive motor for moving the released cup to the downspout of the funnel; and the conveyer drive motor and the auger motors being operatively coupled to a controller and responsive to control signals for actuation.

According to another embodiment, there is provided a computer readable memory for storing data and information for access by an application program being executed on a computer, said data and information being associated with a vending kiosk configured for dispensing bulk products stored in a plurality of bins in response to a customer request, the computer readable memory comprising: a data structure configured in the computer readable memory for storing data associated with a system configuration for the vending kiosk; and a data structure configured in the computer readable memory for storing data associated with a vending session for the vending kiosk.

According to another embodiment, there is provided a mechanism for monitoring the operation of a vending kiosk based on the operation of one or more subsystems associated with the vending kiosk, the mechanism comprising: an interface for receiving a request from an external source; means for processing the request and selecting one of the subsystems based on the request; means for querying the selected subsystem; means for receiving data from the queried subsystem and transmitting the data to said external source.

According to an embodiment, there is provided a bin for dispensing a bulk product in a vending machine, the bin comprising: a storage volume for storing the bulk product; a lid for enclosing the storage volume; an opening for releasing the bulk product from the storage volume; a bin scoop configured adjacent the opening, and operatively coupled to an actuator to dispense a portion of the bulk product through the opening.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional and other features of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

Reference will now be made to the accompanying drawings which show, by way of example, embodiments of the present invention, and in which:

FIG. 1 shows in diagrammatic form a dispensing apparatus according to an embodiment of the present invention;

FIG. 2(a) shows in diagrammatic form a bin according to an embodiment of the present invention and suitable for use with the dispensing apparatus of FIG. 1;

FIG. 2(b) shows in diagrammatic form a right hand side view of the lower portion of the bin of FIG. 2(a);

FIG. 2(c) shows in diagrammatic form the bin of FIG. 2(a) with certain internal components removed;

FIG. 3(a) shows in diagrammatic form a bin scoop configured for the bin of FIG. 2 according to an embodiment of the present invention;

FIG. 3(b) shows in diagrammatic form a bin throat configured for the bin of FIG. 2 according to an embodiment of the present invention;

FIG. 3(c) shows in diagrammatic form a portion control component configured for the bin scoop of FIG. 3(a) according to an embodiment of the present invention;

FIG. 3(d) shows a right side view of the portion control component of FIG. 3(c) positioned inside the bin scoop depicted in a transparent view in broken outline;

FIG. 4(a) shows the bin of FIG. 2 configured with an in-situ agitator according to an embodiment of the present invention;

FIG. 4(b) shows the in-situ agitator of FIG. 4(a) in isolation;

FIG. 5(a) shows a bin lid for the bin of FIG. 2 according to an embodiment of the present invention;

FIG. 5(b) shows a mounting bracket according to an embodiment of the present invention and configured for the bin lid of FIG. 5(b);

FIG. 5(c) shows the mounting bracket configured in the top opening of the bin of FIG. 2;

FIG. 5(d) shows a rod and cork screw configured for the mounting bracket of FIG. 5(c);

FIG. 6 shows in diagrammatic form a database structure according to an embodiment of the invention and configured for storing and retrieving information and data associated with the operation of the dispensing apparatus;

FIG. 7 shows in diagrammatic form a kiosk probe implemented as an API according to an embodiment of the present invention;

FIG. 8 shows in schematic form a system and networkable configuration for controlling the dispensing apparatus according to an embodiment of the present invention;

FIG. 9(a) shows in flowchart form a computer-implemented process for deploying software updates and other process control programs to dispensing apparatus according to an embodiment of the present invention;

FIG. 9(b) shows in flowchart form a computer-implemented process for controlling registered clients;

FIG. 9(c) shows in diagrammatic form a system configuration for controlling and managing the dispensing apparatus over a network;

FIG. 9(d) is a signal flow diagram showing a control sequence for a computer-implemented loader process;

FIG. 9(e) shows in flowchart form a computer-implemented process for a loader update process according to an embodiment of the present invention;

FIG. 10 is a diagrammatic view of a cup dispenser module configured for storing and releasing multiple cups;

FIG. 11 shows a schematic of a sensor circuit according to an embodiment of the present invention.

FIG. 12(a) shows a cup holder configured without the cup alignment ring of FIG. 13(a);

FIG. 12(b) shows a cup holder configured with the cup alignment ring of FIG. 13(a);

FIG. 13(a) shows in diagrammatic form a cup alignment ring according to an embodiment of the present invention;

FIG. 13(b) is a top view of the cup alignment ring of FIG. 13(a);

FIG. 13(c) is a side view of the cup alignment ring of FIGS. 13(a); and

FIG. 14 shows in block diagram form an exemplary implementation for a control unit and controller system and sub-system for the vending kiosk of FIG. 1 according to an embodiment of the present invention.

In the drawings, like elements are indicated by like components.

### DETAILED DESCRIPTION OF THE EMBODIMENTS

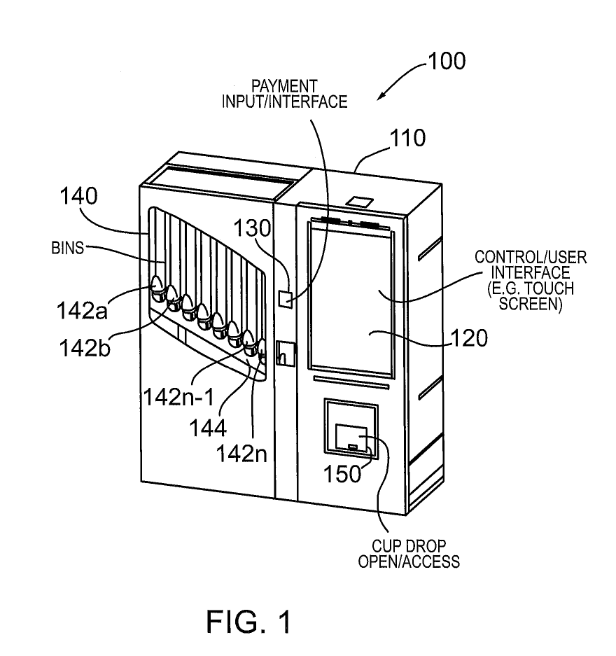

Reference is first made to FIG. 1, which shows a vending and dispensing apparatus according to an embodiment of the present invention, and indicated generally by reference 100. As shown, the dispensing and vending apparatus 100 (i.e. a vending machine or vending kiosk) comprises an enclosure (e.g. cabinet or housing) indicated generally by reference 110, a control panel for a user interface 120, a payment unit 130, and bin compartment 140. The bin compartment 140 is configured to hold one or more bins 142. The bins 142 are indicated individually by 140a, 140b, . . . 140n. The bins 142 store product and the number of bins 142 used in an implementation of the apparatus 100 will depend on factors such as the types and number of the products being offered, the size of the apparatus 100, etc. According to one implementation, the control panel 120 is coupled to a control unit 122 (FIG. 14) comprising a computer or computing device, e.g. one or more microprocessors or programmable devices, operating under stored program control, e.g. software or firmware stored in non-volatile memory or other computer readable media, and utilizing data and other operational information stored in memory or on other computer readable media.

According to an embodiment and as shown in FIG. 14, the control unit 122 comprises a computer 1400, e.g. a personal computer or PC based platform, and one or more control boards 1410 comprising one or more microprocessor based control circuits, operatively coupled to the PC and other system components. According to an embodiment, the control board 1410 comprises an input/output interface 1420 which is configured for outputting control signals and other control data/information, e.g. to the bins 142 and bin motors/actuators and other system components and sub-systems as described below, and inputting status signals and other output data/information, for example, from the bins 142, sensors and other system components and sub-systems as described below. The control board 1410 is operatively coupled to the computer 1400 and is responsive to commands, status requests and other control information from the computer 1400. The computer 1400, e.g. PC, is configured to run or execute one or more computer programs, software modules and the like, to provide the functionality as described in more detail below. The computer programs can be stored in non-volatile memory, disk drives or other computer readable storage media, and according to an embodiment can be updated remotely, as described in more detail below. The microprocessors for the control board(s) operate under stored program control, e.g. firmware stored in non-volatile memory, storage devices or computer readable media, and according to an embodiment, the firmware can be updated remotely as described in more detail below.

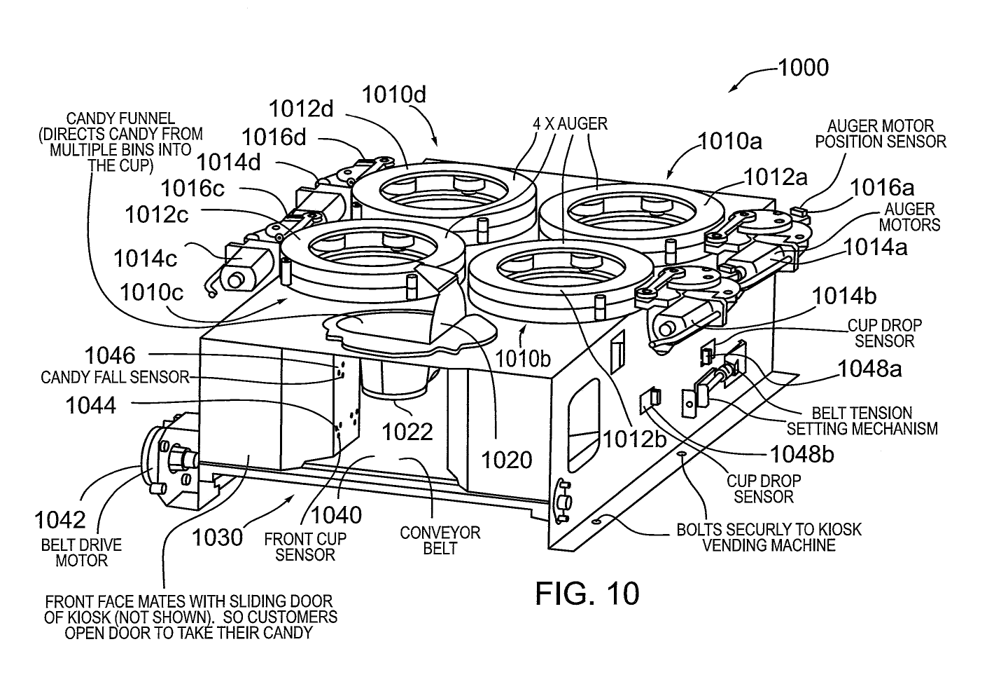

According to one aspect, the control panel 120 comprises a control/command interface for the bins 142. The control unit functions with the associated bin 142 to dispense an exact or an approximate amount or quantity of product specified in weight, product count and/or dollar value by the consumer. According to an embodiment, the apparatus 100 includes a container access opening 150. The container access opening 150 is integrated with a container dispensing module, which is described in more detail below with reference to FIG. 10. The container dispensing module is operatively coupled to the control unit and responsive to control commands for dispensing a carton, cup or box with product filled from one of the bins 142, and the filled cup is removed from the container access opening 150 by the customer.

The control panel 120 is utilized by a user, e.g. a consumer, shopper, customer, etc., to select the product and specify an exact or an approximate quantity of the product, and then purchase, dispense or otherwise acquire the product, as will be described in more detail below. The control panel 120 comprises a main or central controller, a keypad and a display module, or a touch-screen. In another embodiment, the control panel 120 is implemented in the form of a voice-activated device and a display device. The control panel 120 is responsive to inputs from a customer and generates output data or signals for a control application or program. The control application responds to the inputs from the customer and operates the apparatus 100 to dispense or vend the product as will be described in more detail below. The control application is implemented in software and comprises, for example, a stand-alone computer program or software module or firmware application or function, which is executed by the control unit to control the interaction between the customer and the apparatus. The control application 112 may reside on a device or hardware component that is integrated with the control panel 110, for example, as shown in FIG. 1.

It will be appreciated that the vending machine or apparatus 100 according to an embodiment of the present invention can be implemented or function in two ways or modes: vending mode and dispensing mode. In vending mode, the apparatus 100 is implemented as a vending apparatus 100 wherein a user selects a product and specifies a quantity (i.e. exactly or approximately by weight and/or dollar value) of the product desired for purchase, and the apparatus 100 dispenses the specified quantity of the product upon receiving payment. The vending implementation of the apparatus 100 is suitable for commercial applications, such as, grocery stores, bulk food stores, vending kiosks, etc. In dispensing mode, the apparatus 100 is implemented as a dispensing apparatus wherein the apparatus 100 dispenses the specified quantity of the product selected by the user without requiring payment. The dispensing implementation of the apparatus 100 is suitable for non-commercial applications, for example, a private club, a daycare, etc. According to an embodiment, the apparatus 100 is convertible to a dispensing apparatus by disabling the payment unit 120 and/or the payment function or module in the control application.

In the context of a vending application or implementation, once a user has selected the product and quantity desired, the apparatus prompts the user to pay for the purchase using the payment unit 130. The control unit includes a function or module to calculate the cost of the product purchase and the purchase price is displayed for the user on control panel 120. The user pays the purchase price using the payment unit 130, and the payment unit 130 is implemented to accept as payment in multiple forms, such as, coins or bills, tokens, smart cards, credit or debit cards, or any combination of these. The tokens may be purchased from a third-party or from a token dispenser (not shown) associated with the vending apparatus 100.

Once the correct payment is received by the payment unit 130, the dispensing of the selected product and the specified quantity begins. According to an embodiment, the control unit is implemented as an intelligent device that runs or executes a dispensing application or program (e.g. implemented in software and/or firmware), which functions to dispense the specified quantity of the selected product into a container (e.g. a cup) through the operation and actuation of the integrated bin and bin scoop as described in more detail below.

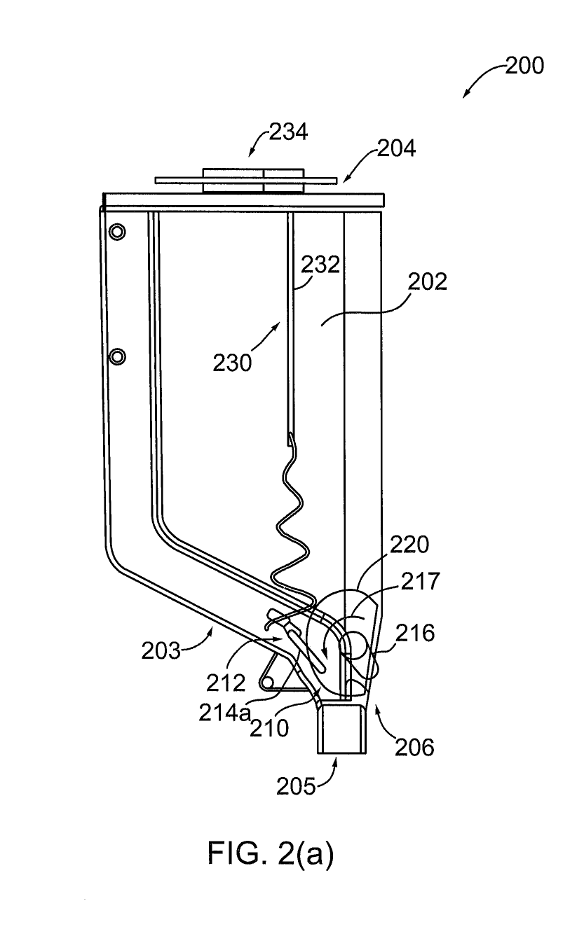

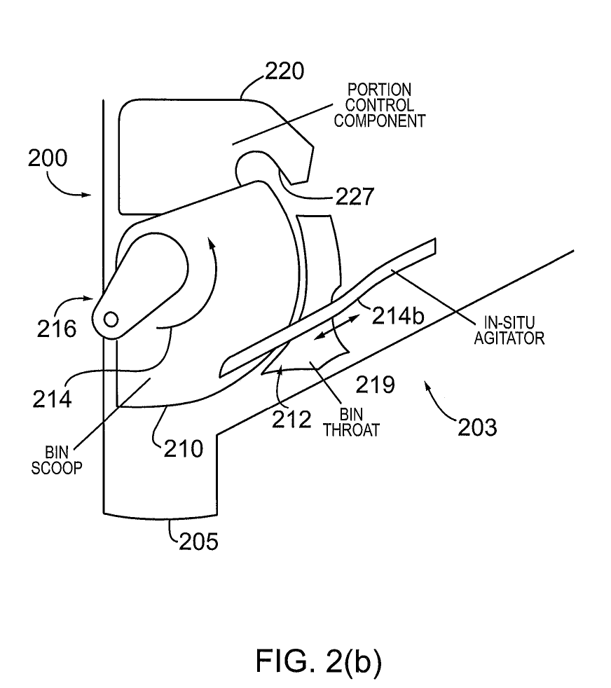

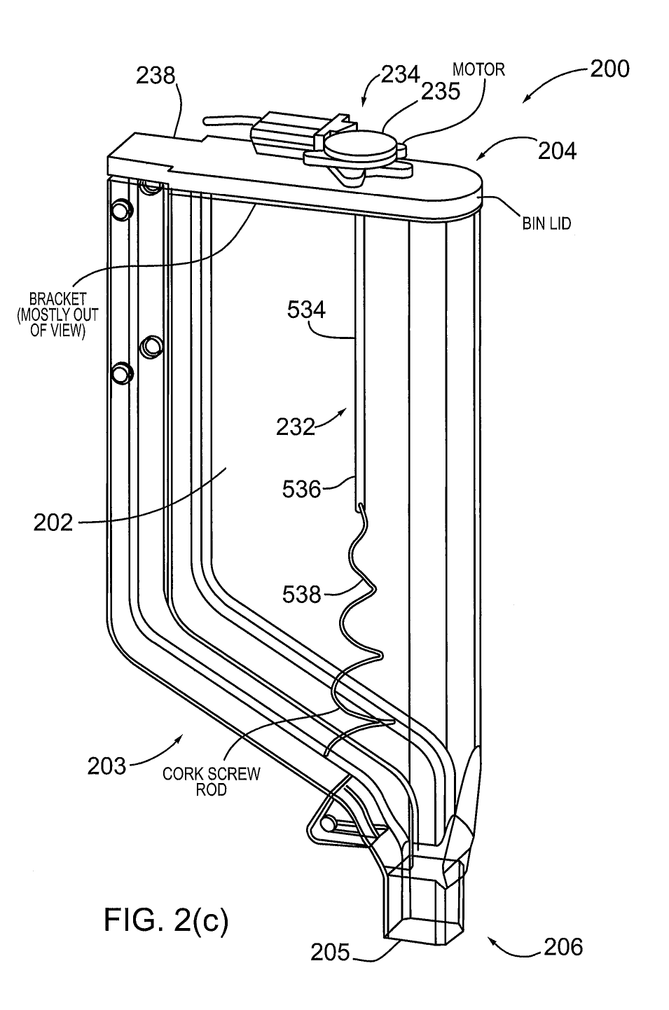

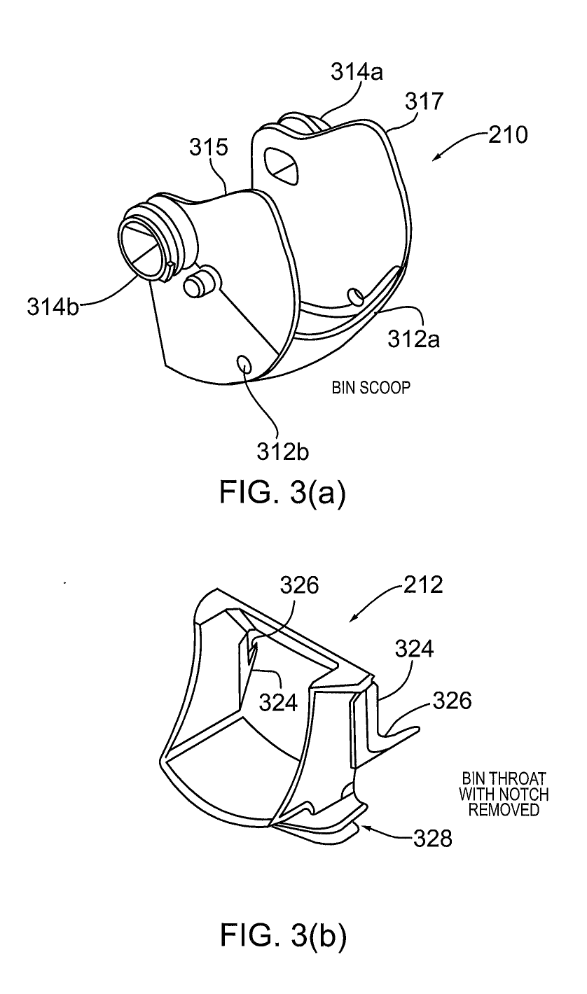

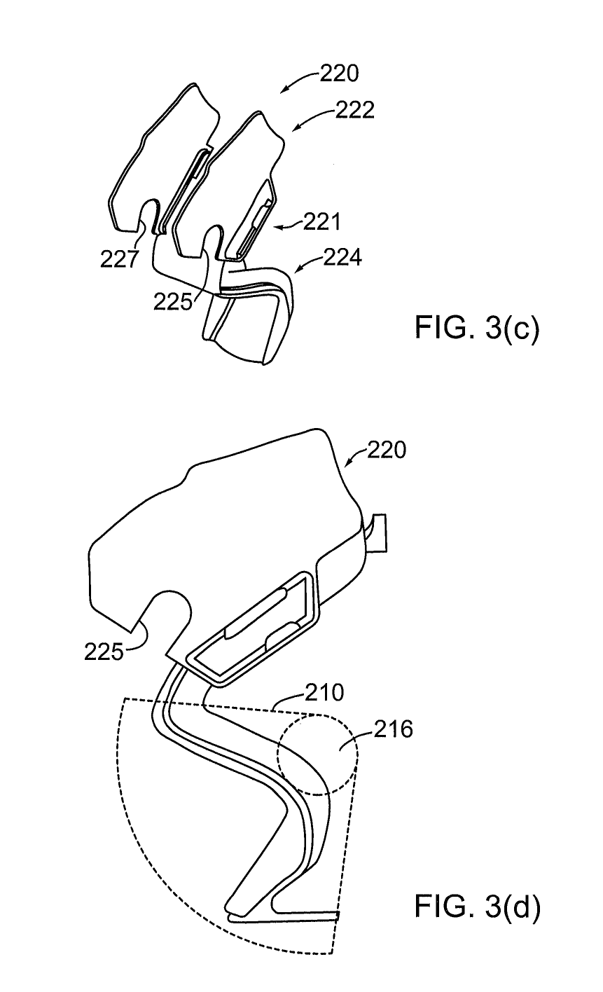

Reference is next made to FIG. 2(a), which shows a bin according to an embodiment of the present invention and indicated generally by reference 200. The bin 200 as shown in FIG. 2 comprises a bin storage volume 202, a top end 204 and a bottom end 206. The bin storage volume 202 comprises a lower portion 203 with a sloping bottom that is configured to direct or funnel product towards the bottom end 206. According to an embodiment, the bin 200 is configured with a bin scoop indicated generally by reference 210 and a bin throat component indicated generally by reference 212. The bin scoop 210 is shown in more detail in FIGS. 2(b) and 3(b), and the bin throat component 212 is shown in more detail in FIG. 3(b).

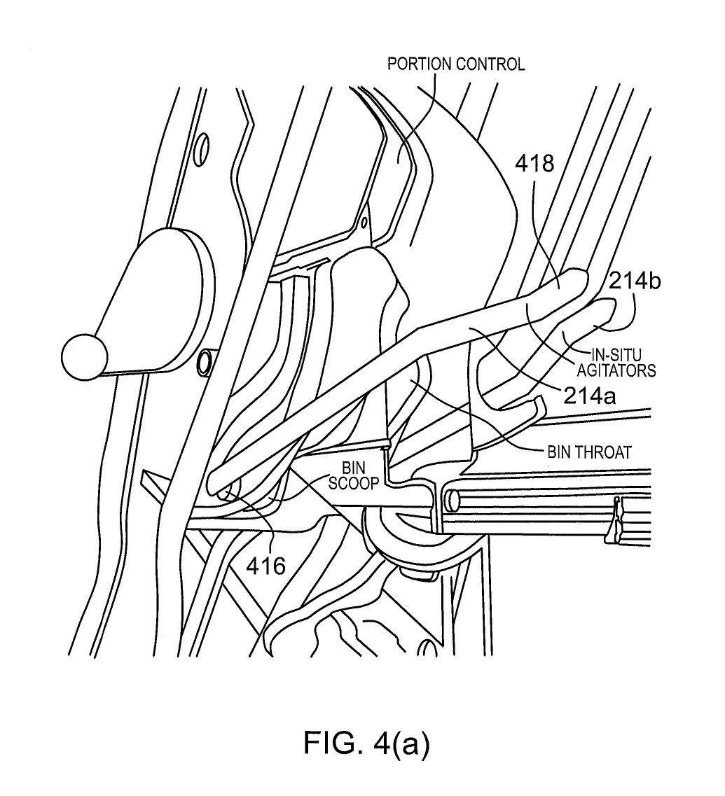

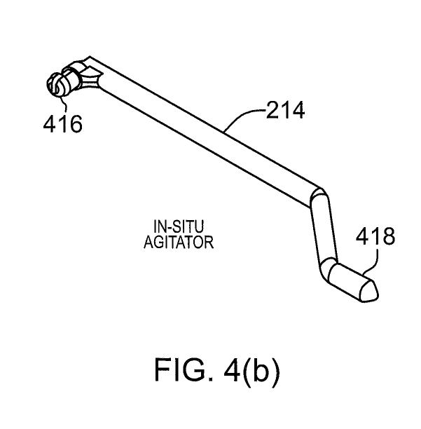

According to an embodiment, the bin 200 is configured with an agitation mechanism. The agitation mechanism comprises one or more agitation arms indicated generally by reference 214. According to an embodiment, and as shown in FIG. 2(a), the bin scoop 210 is shown with an agitation arm attached or coupled to the left side and indicated by reference 214a. Similarly, the bin scoop 210 includes a second agitation arm attached to the right side and indicated by reference 214b in FIG. 2(b). The agitation aim 214 according to an embodiment is further depicted in FIGS. 4(a) and 4(b). The agitation arms 214 are configured to agitate, stir or otherwise move product that is in the vicinity of the bin scoop 210, and actuated by movement of the bin scoop 210. In an exemplary implementation, the bin scoop 210 is configured with an actuator indicated by reference 216 in FIGS. 2(a) and 2(b). The actuator 216 comprises a servo motor or other type of drive mechanism or gear mechanism that is responsive to the control signals from the control board 1410 (FIG. 14) to move the bin scoop 210 between a product fill position and a product dispense position, i.e. generally in the direction of arrow 217. As the bin scoop 210 is moved between the product fill, and the product dispense positions, the agitation arms 214 move in a generally arcuate and/or linear and reciprocal direction indicated generally by arrow 219. This has the effect of mixing or agitating the product in the proximity of the bin scoop 210 (and the bin throat 212 if installed) and thereby preventing product (e.g. candy) from sticking together if left undisturbed.

As shown in FIG. 3(a), the bin scoop 210 is configured with apertures or other suitable openings indicated by references 312a and 312b for coupling or attaching one end of the respective agitation arm 214. As shown in FIGS. 4(a) and 4(b), one end of the agitation arm 214 is configured with a snap fitting or other coupling mechanism 416 that is pressed or fitted into the respective aperture 312 (FIG. 3(a)) to secure the arm 214 to the bin scoop 210. The other end of the agitation arm 214 can be configured or shaped with one or more bends indicated generally by reference 418 to match the geometry or shape of the bin 200, and/or put the arm end 418 substantially into the middle region or area of the interior of the bin 200. According to another embodiment, the ends 418 of the two arms 214a and 214b are joined or coupled together. According to another aspect, the agitation arms 214 are configured with a circular or oval cross section to facilitate movement of the arms 214 through the product. As shown in FIG. 3(a), the bin scoop 210 is configured with a coupling mechanism 314a and 314b, for instance, a snap fit connector, for coupling a drive or gear mechanism.

The bin 200 can be configured with the bin throat 212 as described above. The bin throat 212 functions as a type of funnel and is configured to facilitate the movement of product into the bin scoop 210. As shown in FIG. 3(b), the bin throat 214 includes guide members 324 to help funnel product into the opening of throat and the bin scoop 210. According to an embodiment, the guide members 324 include respective notches or cut-outs indicated generally by reference 326. The notches or cut-outs 326 allow the agitation arms 214 to move back and forth into the product as described above. According to another aspect, the notches 326 can be configured to act as guide and/or fulcrum or support surface for the respective agitation arms 214a and 214b. According to an embodiment, the bin 200 is formed or fabricated from a plastic or composite material, and configured with suitable guide or stop members for engaging corresponding rails 328 and thereby positioning and securing the bin throat 212 inside the bin 200.

In the product fill position (as shown in FIGS. 2(a) and 2(b)), the opening of the bin scoop 210 is communication with the bin throat 212 and product inside the bin 200 enters and fills the bin scoop 210 through one end. When the bin scoop 210 is moved to the product dispense position, the product moves out and falls through an opening 205 in the bottom end 206 of the bin 200 into a cup or other suitable container. To control or limit the quantity of product that enters or fills the bin scoop 210, the bin scoop 210 can be configured with a portion control component as shown in FIGS. 2(a) and 2(b) and indicated generally by reference 220. The portion control component 220 comprises a top section 222 and a lower section 224 as shown in FIG. 3(c). The portion control component 220 is affixed or fitted to the interior of the bin 200, for example, with mating snap fittings indicated generally by reference 221 and the lower section 224 of the portion control component 220 extends into the bin scoop 210 as depicted in FIG. 3(d) and functions to define the interior volume of the bin scoop 210 which can be filled by product. According to another aspect, the portion control component 220 can be configured in different sizes to allow the volume of the bin scoop 210 and the portion volume to be changed by replacing the portion control component 220 in the respective bin 200. As shown in FIGS. 3(c) and FIG. 3(d), the portion control component 220 includes cut-outs or openings 225 and 227. The cut-outs 225, 227 are configured to extend the upward travel (i.e. in the direction of arrow 217 in FIG. 2(b)) of the bin scoop 210 by providing clearance or a void for the respective top edges 325 and 327 of the bin scoop 210.

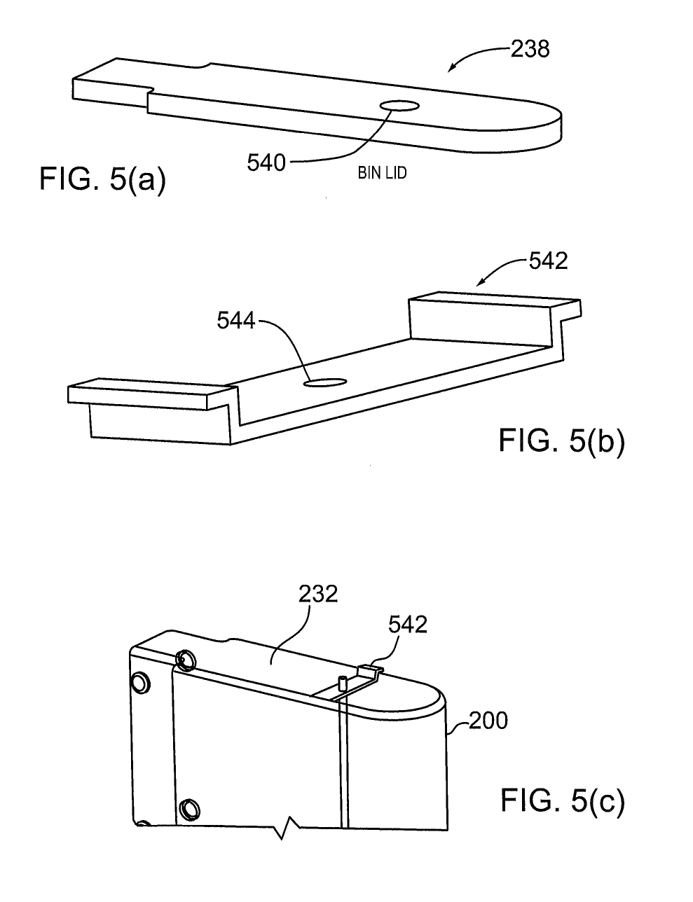

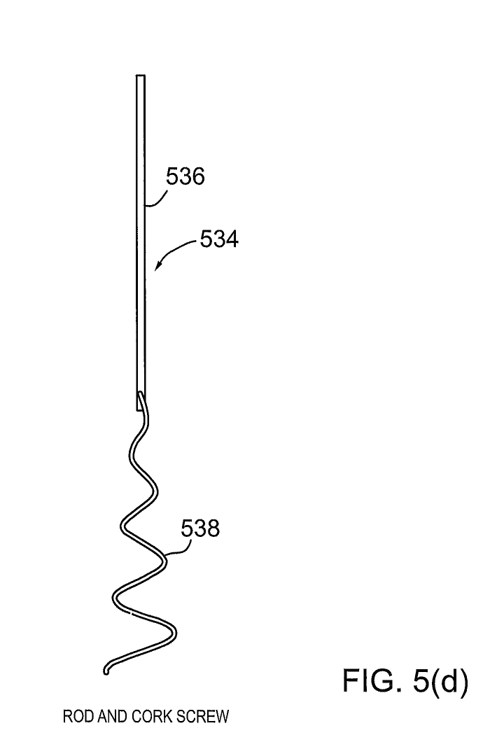

According to another embodiment, the bin 200 is configured with a whole-bin agitation mechanism as depicted in FIG. 2(a) and indicated generally by reference 230. The agitation mechanism 230 comprises a mechanical mixing rod 232 that extends into the bin 200 and contacts the product, and an actuator 234 for moving, e.g. rotating, the mixing rod 232 to agitate the product. According to an embodiment, the mechanical mixing rod 232 comprises a rod 534 with a corkscrew shaped mixing end 536 as shown in FIG. 5(d) and indicated generally by reference 534. The rod 534 is operatively coupled to the actuator 234, for example, a drive motor indicated by reference 235 in FIG. 2(c), and rotated in a counter-clockwise direction to provide a slight lifting action as the corkscrew end 538 passes through the product, e.g. candies. It will be appreciated that the product should not be pushed down as a result of the corkscrew action as this could pack and jam the product into the bottom of the bin 200.

As shown in FIG. 2(c), the motor or actuator 234 is mounted to a bin lid 238 which is secured to the top of the bin 200. The bin lid 238 includes an aperture 540 as shown in FIG. 5(a) for operatively coupling the motor to one end (i.e. the top) of the mixing rod 232. As shown in FIG. 5(b), the bin 200 can include a bracket 542 which is configured, for example, with a pair of flanges, to be mounted across the top of the bin 200 as shown in FIG. 5(c). The bracket 542 includes an aperture or hole 544 for supporting the mixing rod 232 and allowing the rod 232 to be coupled to the motor 234. According to one aspect, the bracket 542 holds the mixing rod 232 in place when the bid lid 238 (and the motor 234) are removed, for example, to refill the contents of the bin 200. According to an embodiment, the drive motor 235 is operatively coupled to the control board 1410 (FIG. 14) and responsive to control commands issued by the control board 1410.

According to another embodiment, the mechanical mixing rod 232 comprises a rod with flanges that protrude out from the rod to provide additional contact with and agitation of the product. According to another aspect, the flanges are configured to be asymmetrical in order to provide less resistance when the rod is inserted/forced into the product and also provide some lift, or aeration, of the product when the rod is retracted. According to an embodiment, the rod is oriented vertically into the bin 200 and operatively coupled to the motor to move up and down vertically in the product.

According to another embodiment, the bin 200 can be configured with more than one mixing rod with each having a respective motor, or with one motor coupled to the multiple mixing rods through a gear or belt drive mechanism.

According to another embodiment, the control unit 122 (FIG. 14) for the apparatus 100 includes a component for monitoring the current load during operation of the bin scoop 210 (FIG. 2(a)), and preventing an overload condition on the bin motor or actuator for the bin scoop. According to an exemplary implementation, the control board 1410 (FIG. 14) is configured with a resistor and an analog to a digital convertor circuit or subsystem. The current through the resistor is indicative of the current load on the motor and the resulting voltage is converted to a digital value which is inputted and processed by the control board. According to an exemplary implementation, the control unit is configured or programmed with a current load function which includes a maximum current setting and one or more trip current settings. Due to typical surge current on start-up, the current readings are ignored by the control unit, for example, for the first 100 milliseconds. After the start-up, if the current trip current setting is exceeded, the control unit responds by stopping the bin motor or actuator, and reversing the direction of the motor and backing up the bin scoop and increasing the trip current level setting. The control unit then resumes normal operation of the bin scoop. If the new trip current level is exceeded, the control unit backs the bin scoop up a further distance, the trip current level is increased to a maximum current level, and normal operation of the bin scoop is resumed. If the current level is again exceeded, then an error condition exists, e.g. there is a jam with the bin scoop and/or product, and the associated bin is shut down. The control unit issues an error message and/or diagnostic message for an administrator, e.g. a remote computer.

According to another aspect, the control unit 122 is configured to perform a process for un-jamming product, e.g. candy, in one of the bins by measuring the current and if at any point the current exceeds a set value, performing the following processing steps:
(1) stopping the motor for approximately 100 millisecond to let voltages and currents settle
(2) reversing or backing up the motor for a predetermined amount of time to reverse the bin scoop
(3) stopping the motor for 100 milliseconds to allow the current and voltage levels to settle
(4) increase trip current and run motor forward to actuate bin scoop, e.g. move bin scoop to the dispensing position
(5) if trip current level is exceeded, steps (1) to (4) are repeated two more times with each time the motor backing up slightly more and the trip current increased until at the maximum current level setting is reached
(6) if at this point the blockage is still there, an error exception condition is “thrown”, i.e. issued

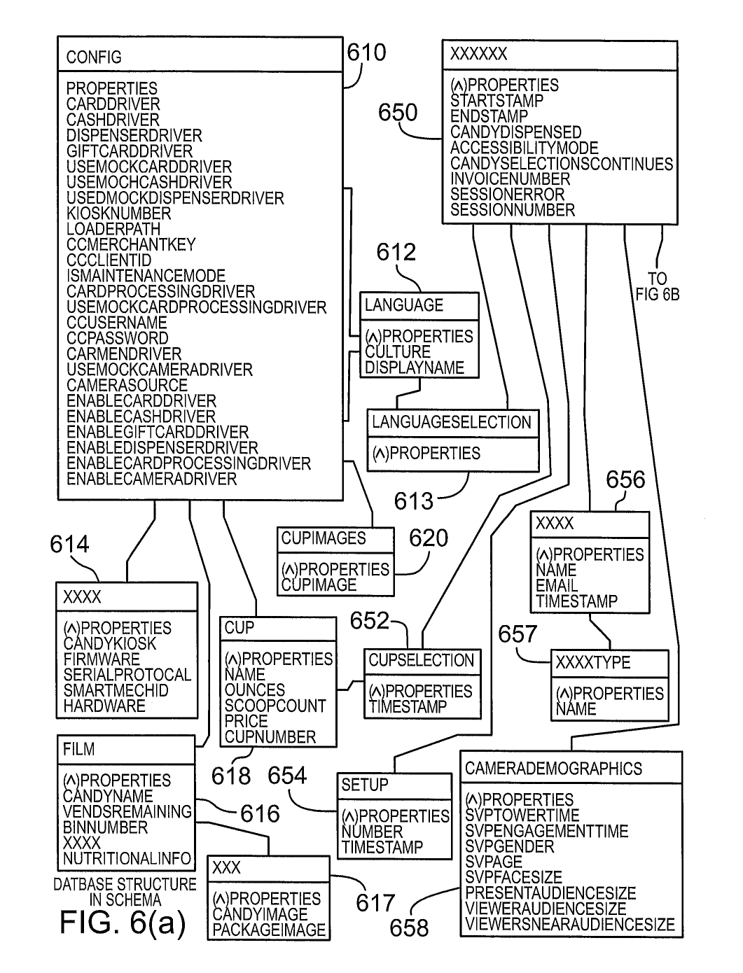

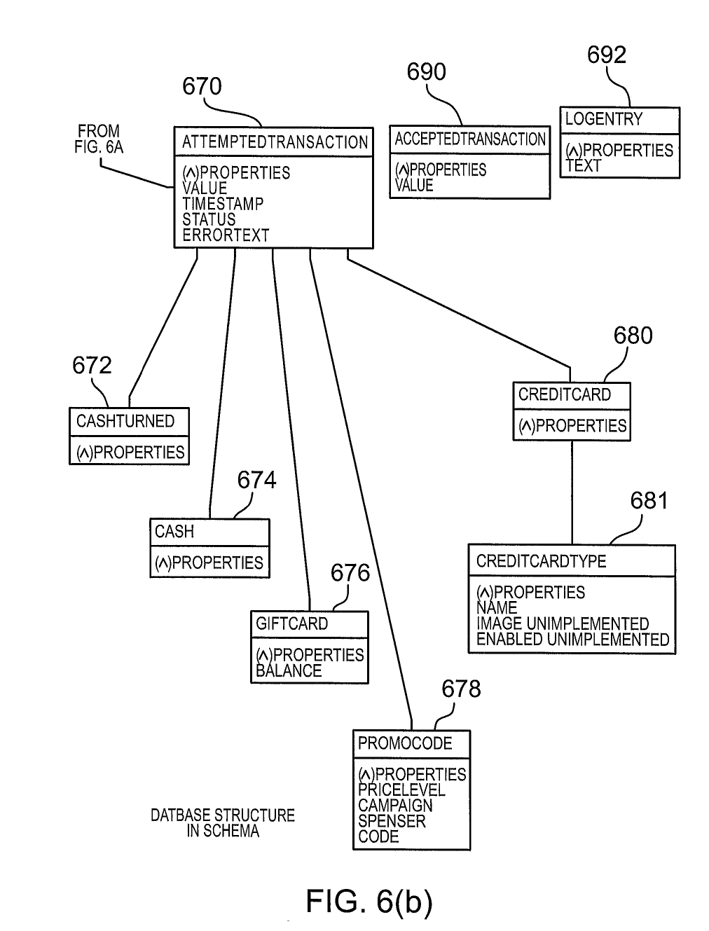

Reference is next made to FIG. 6, which shows a data structure configuration or data schema indicated generally by reference 600 for storing operational data and other information associated with the vending apparatus 100. The database structure 600 and associated data are configured and stored in non-volatile memory or mass storage media accessible by the computer. According to an embodiment, the data schema 600 comprises a “Config” data structure or object indicated by reference 610 and a “Sessions” data structure or object indicated by reference 650. The Config data structure 610 is associated with a “Language” data structure or object 612 (which is further linked to a “LanguageSelection” data structure or object 613), a “Version” data structure 614, a “Bin” data structure 616 (which is further linked or associated with a “BinImages” data structure or object), a “Cup” data structure 618, a “CupImages” data structure 620. As shown, the Session data structure or object 650 is associated with a “CupSelection” data structure or object 652, a “Scoop” data structure 654, a “SignUp” data structure 656 (which is further linked or associated with a “SignUPType” data structure 657) and a “CameraDemographics” data structure 658. As shown, the Session data object 650 is also linked to the LanguageSelection data object 613. The Session data object 650 is also linked or associated with an “AttemptedTransaction” data structure or object 670, which, as shown, is linked or associated with a “CashPreferred” data structure or object 672, a “Cash” data structure or object 674, a “GiftCard” data structure or object 676, a “PromoCode” data structure or object 678 and a “CreditCard” data structure or object 680 (which is further linked or associated with a “CreditCardType” data structure or object 681). As also shown in FIG. 6, the data structure or schema can further comprise a “AcceptedDenomination” data structure or object 690, and a “LogEntry” data structure or object 692.

According to an embodiment, the database structure 600 is implemented utilizing a transactional SQL database engine, such as, SQLite. For example, each time a customer starts to use the vending machine, a “Session” is created. The user chooses a cup size (a Session instance is related to 1 CupSelection instance), multiple scoops (a Session instance is related to multiple Scoop instances). The user payment information is stored in AttemptedTransactions. Each bill entered creates an instance of the Cash Entity which derives from AttemptedTransaction (Cash is a type of AttemptedTransaction). CreditCard, GiftCard and PromoCode transactions can also exist. Most AttemptedTransactions will have a Status of success however failed credit card, gift card or promo-code transactions will have a failed Status. Once a Session is complete, it is stamped with an EndStamp. If candy was dispensed then the CandyDispensed flag is set. An InvoiceNumber is generated for each session with a payment and it is sent to the credit card company during credit card processing. Cup choices, scoop choices and the related graphics can all be configured in the database (for example, using an administrative function, e.g. an AdminPanel). Alternative drivers can be configured (for example, copy the DLL in and configure the driver name and location in the AdminPanel).

According to an embodiment, the data and operational data collected and/or stored (along with machine ID and date/time stamps) comprises:
(1) transaction data such as product type, price, amount, payment type, payment amount, transaction ID, electronic transaction ID or authentication number
(2) interface data such as media played, audio played, graphics displayed, buttons touched, session duration, screen touches
(3) service data such as person logged in, software reboots, computer reboots, connection issues, errors, warnings, notices, events, product fill dates
(4) performance data such as current, amperage used
(5) external customer data such as age, gender, ethnicity, whether or not they looked at the machine, length of look, customer height, color of clothes, an image or video of the customer (optional)
(6) configuration data such as product types, vend amounts, prices, names, pictures, recipes, language translations, server addresses, account information, scheduling
   The control unit 122 at the vending apparatus 100 can be configured to store and/or use this data in a number of unique combinations that allow for value to be generated for the operators and the brands that sponsor kiosks.

According to an embodiment, external customer data is obtained through a device or through a camera operatively coupled to the control unit or another computing device in the vending apparatus or kiosk. Images from the camera are analyzed to generate the data using image analysis techniques. The external customer data can also come from other sources, such as Facebook profile information or provided by the customer through registration with a website.

According to an embodiment, external customer data correlated with transaction data is stored. This allows for the study of purchasing and payment patterns based on demographics, for example, in the situation where the uniqueness of an individual customer can be verified.

According to an embodiment, interface data correlated with transaction data is stored. This allows for the study of interface patterns such as products chosen, products deleted, order of products displayed, with the purchase data from transactions. This can show, for example, if there is a preference for certain products early in the purchase process (impulse) and then a later preference for different products (reasoning), for example, allowing comparison of healthy versus unhealthy products.

According to an embodiment, external customer data correlated with interface data is stored. This allows for the study of interface patterns with information about the customer. This could show, for example, patterns of interface behavior in certain groups. For instance, it could show that the elderly have difficulty with a certain part of the purchase process. It could show a preference for using with the screen in a certain way for a certain gender (tap vs. touch). It could also show that certain demographics are likely to walk away when they get to the pricing page.

According to an embodiment, configuration data from a vending machine is replicated and stored on a central or remote server. This also allows for central configuration data to be deployed out to all the machines. This aids in installation because a machine can be pre-configured to have all the applicable data automatically set up based on the machine ID and install location.

According to an embodiment, the database structure 600 and control unit are configured to track and store inventory data. According to an embodiment, the control unit is configured (e.g. through software) to store inventory data locally at the apparatus and also transfer data to a remote site, e.g. a central data server. This configuration allows for reports to be compiled for customer use. It also allows for inventory data to be used to scale manufacturing as needed. It can also be used to control logistics and shipping, for example, by sending certain operators the appropriate amount of product and a list of locations where the product is to be delivered. In an exemplary implementation, a machine ID destination is associated with each individual container of product. The inventory data is updated when the vending machine is serviced. The control unit can also be configured (e.g. programmed) to attach a service person's ID to the event. According another aspect, the amount of time that product has been in a bin is tracked. Because bins operate on an approximate “first in, first out” system, the control unit is configured (e.g. operating under stored program control) to calculate how much product must be removed from the bin in order to keep only the freshest amount of product in the bin. According to a further aspect, the control unit is configured to automatically dispense stale product into a cup for free or for disposal. According to another aspect, the control unit is configured with an inventory tracking system where the appropriate bin is selected (e.g. lighted) based on scanning entering data from the product container label.

According to an embodiment, the control unit for the vending machine 100 is configured for transferring data between the machine 100 and another device, e.g. another vending machine, a computer, a central server, administrator, etc. As described above, the control unit is configured to capture and store data and operational information in the database structure 600. According to a further aspect, the data is synchronized, and in one implementation, the vending machine or kiosk 100 is configured with a regular synchronization interval. The control unit (e.g. the computer) communicates with a central server, and uploads database data (e.g. new data captured at the machine 100) and downloads any new data or updates to the machine from the central server. In a typical installation, the data uploaded from the vending kiosk 100 typically comprises transaction data, and the data downloaded from the central server comprises configuration or media data, and software and code updates. This provides the capability to install updates and fixes to one or more of the vending machines or kiosks via a network (e.g. Internet) connection. According to another aspect, the synchronization operation comprises uploading data related to the current status of one sub-systems in the vending machine or kiosk 100. According to another aspect, the synchronization interval comprises either a fixed time-based value, or a dynamic interval, for example, based on sales traffic, customer traffic, data/records generated since last synchronization operation. Accord to another aspect, kiosk specific commands can be packaged in a designated type of database record or object. Commands that the kiosk is to execute can be sent through a special type of DB record. To bandwidth requirements and operating costs the transfer data can be compressed using known techniques.

According to an exemplary implementation, the control unit (i.e. the computer) in each vending machine or kiosk is configured to query the central server (i.e. a loader server) periodically (at a configurable time interval) and send an identifier which identifies the kiosk to the loader the server. In response, the loader server is configured (e.g. through computer software or stored program control) to send back a checksum of the current version information file deployed to the kiosk. If the checksum does not match the version information at the kiosk, then the required updates are downloaded to the kiosk to bring the software and any other programmable components up to date. In accordance with this implementation, the control unit at the kiosk is configured to decompress each update and then execute an installation script included in the update. In addition to updates from the loader server, the database record system can be configured to supports synchronization between client and server databases. For instance, data from each of the vending machines or kiosks can be tabulated and sent to the central server. This data enables detailed marketing reports to be generated on, for example, usage trends, market payment type preferences, the speed at which the user proceeds through various screens, market demographic information captured from images taken by a TruMedia camera, and email sign-ups. The synchronization operation also comprises data on the current status of one or more of the subsystems in the vending machine or kiosk. The synchronization of data can also comprise encrypted communications, such as, a SSH tunnel or a HTTP based SSL connection. According to another implementation, data can be encrypted using encryption key pair unique to a specific customer or group of customers.

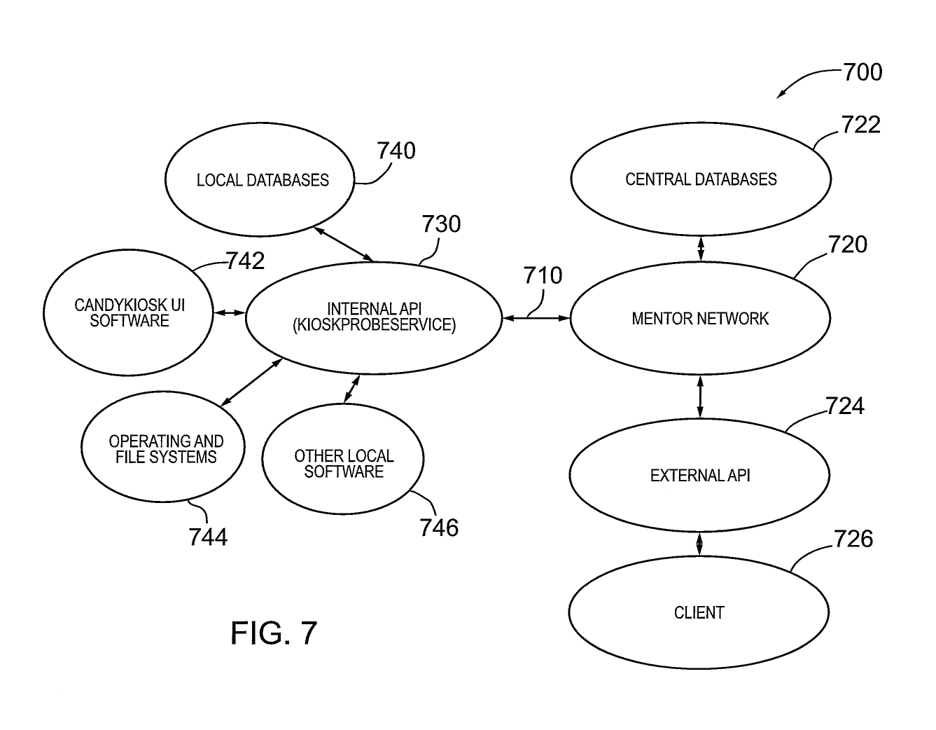

Reference is next made to FIG. 7, which shows in diagrammatic form a software configuration 700 for transferring data from the vending machine or kiosk via a network connection 710 to a central server 720 and other devices or entities. According to an embodiment, the vending machine 100 is configured with a kiosk probe indicated by reference 730. As described in more detail below, the kiosk probe 730 comprises one or more API's and is implemented and configured to provide an interface for monitoring the other software subsystems, including as shown in FIG. 7, a local database module 740, a user interface software module 742, operating and file system 744, and other software components or modules indicated generally by reference 746. The kiosk probe 730 is configured using known computer software and programming techniques to monitor the system health of the kiosk and respond to requests (for example, from the central server 720) for status and other system information. For example, the kiosk probe 730 can be configured to report on both current, or historical, status of a kiosk. According to one implementation, the kiosk probe 730 is configured to track the following data: computer usage (for example, hard drive• usage, RAM usage); current status of the kiosk components, such as, bin status and amount of product in each bin; status of the payment methods (eg: credit card reader, VNR, coin acceptor); statues of software systems, subsystems or modules; sales per hour/day. According to another aspect, the kiosk probe 730 comprises a service that runs on the kiosk operating system and is responsible for managing external data transfer and kiosk control commands with a central server or administrator control network indicated generally by reference 720.

According to an exemplary implementation, the kiosk probe 730 is configured to provide the following functionality:
(1) a client 726 initiates a request using an external API 724 to the central server or administrator control network 720. The request can be secured with encryption and/or authentication
(2) The administrator control network 720 is configured to route and initiate a request to the appropriate kiosk connected to the network 710
(3) the kiosk probe 730 on the vending machine accepts the API request and processes the request at the vending machine
(4) the kiosk probe 730 transmits the results of the request back to the control network 720, either synchronously or asynchronously
(5) the control network 720 compiles or otherwise processes the received data and generates data, for example, a summary or report on kiosk back to the client 726
(6) the client 726 accepts the kiosk results and the request is completed

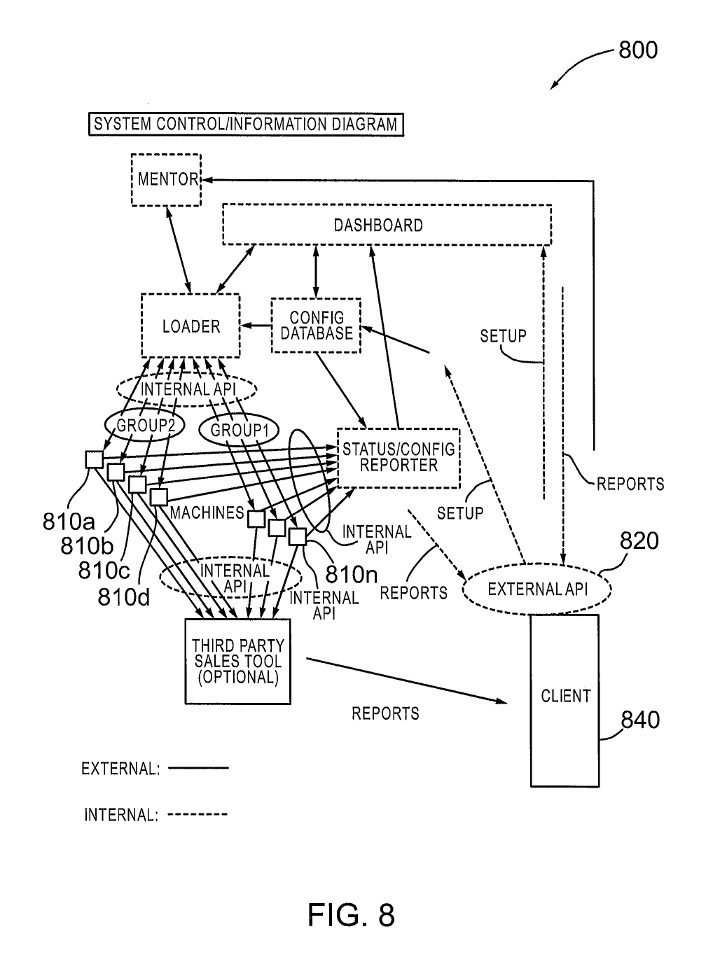

Reference is next made to FIG. 8, which a software system configuration or architecture 800 for controlling a plurality of vending machines or kiosks 810, indicated individually by references 810a, 810b, 810c, 810d, . . . 810n. As shown, the system configuration 800 comprises multiple Application Programming Interfaces or API comprising functions for data storage, data transfer, kiosk control, dashboard and reporting systems. This allows for each component to be abstracted and separate from each other. According to an embodiment, the system 800 comprises an external API indicated by reference 820. The external API 820 further comprises three functional modules: (1) kiosk control; (2) reporting; and (3) content control. For kiosk control, the external API 820 comprises a kiosk control API that is configured to provide fine granularity control (i.e. “setup”) of kiosk functions, such as,
enabling and disabling bins, cup droppers
enabling and disabling LED lights
enabling and disabling payment options
   For reporting, the external API 820 comprises a reporting API that is configured to provide a mechanism for querying various reports from the kiosks 810 such as:
sales per time frame
product status
historical kiosk activity
error reports and summaries
   For content control, the external API 820 comprises a content API that is configured to provide a mechanism for transmitting data or advertising content to the kiosk. The content API can also be configured with rules for how/when content should be presented on the kiosk. For clients (indicated generally by reference 840), the kiosk probe provides the capability to report on sales activities, push content such as media to the kiosk, and change configurable parameters (such as, kiosk on/off schedule, kiosk lighting schedule).

According to an exemplary implementation, the control unit (i.e. computer) on each vending machine or kiosk is configured with a loader program. The loader program checks in with the central server. The check in interval is determined in a configuration file on the machine but can be changed via the remote update system. Each software package is associated with a “channel”. The version for the software package and for the channel on a kiosk are compared, as well as the time stamp for each compared, and the latest package is deployed. The version information for each vending machine is stored in a manifest file, coded in XML. A copy of the deployed manifest for each machine is stored on the central server. When a machine “checks-in”, the manifest on the machine is compared to the manifest on the central server to determine what packages, if any, are installed. The kiosk then downloads any necessary packages and installs them, and is configured to report to the central server, and the central server in turn records a successful installation. If the install fails, then the original software is restored and the machine continues to under that operate with the original software.

According to another aspect, the loader mechanism is configured to be updatable utilizing a deployed and delayed installation package. The package is configured to not run fully when downloaded, but instruct the operating system to perform certain commands at reboot. When the machine is rebooted these commands update the Loader component of the machine before it is run. In a further aspect, numerous packages can be bundled together using a meta-package structure. Packages can also be deployed incrementally where a package depends on certain other packages to having been present first. The meta-package can also specify the order of installation and whether an internal package is critical to overall success or is optional. According to another aspect, the system is configured with a deployment scheduler that allows for packages to be deployed during certain hours (for example, at night). According to another aspect, vending machines or kiosks can be grouped together in numerous ways, such as by geography, equipment type, or operator and packages deployed accordingly.

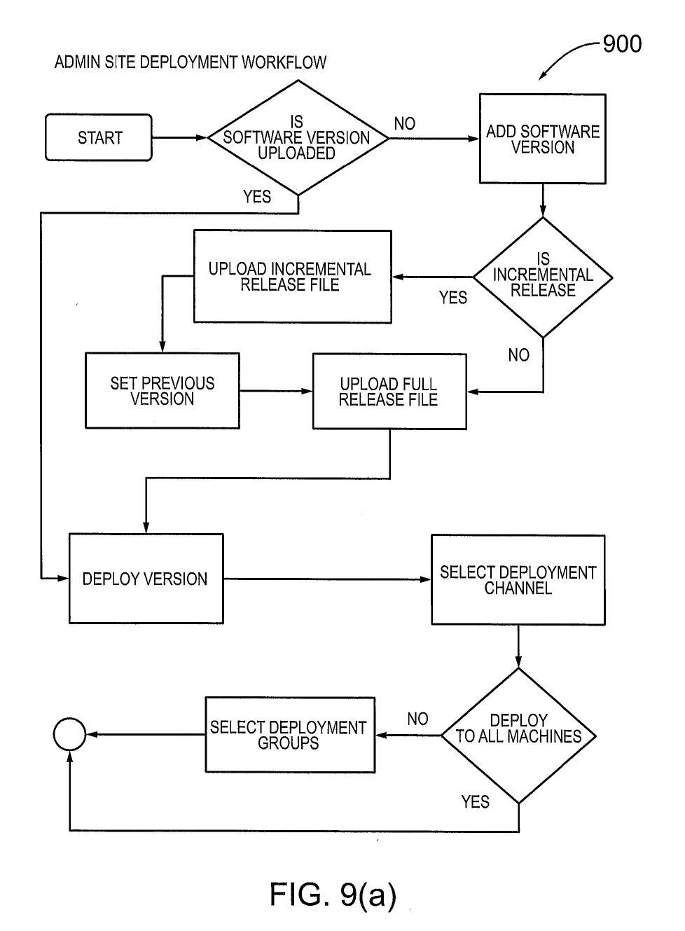

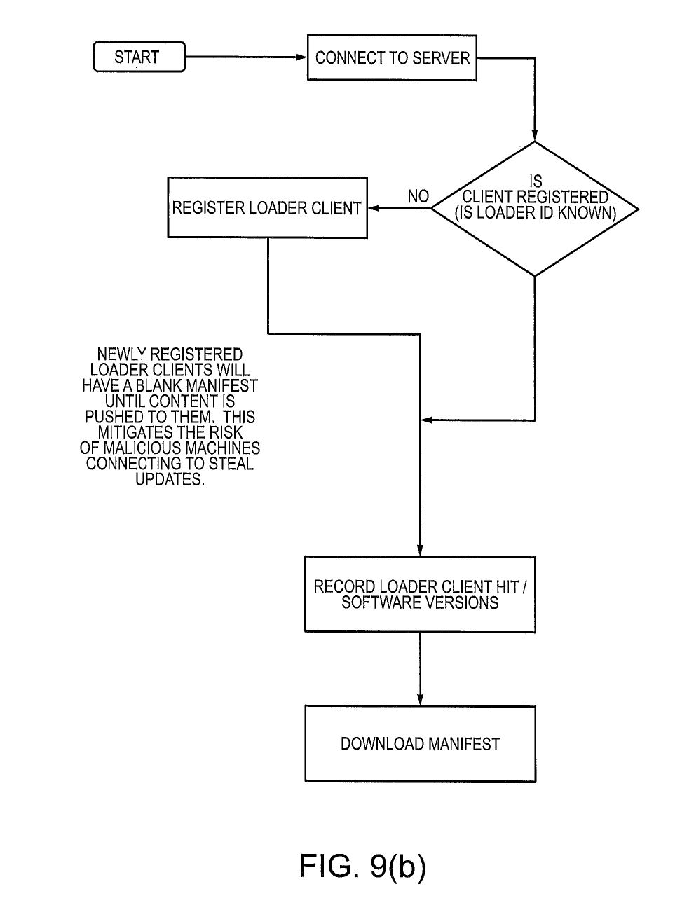

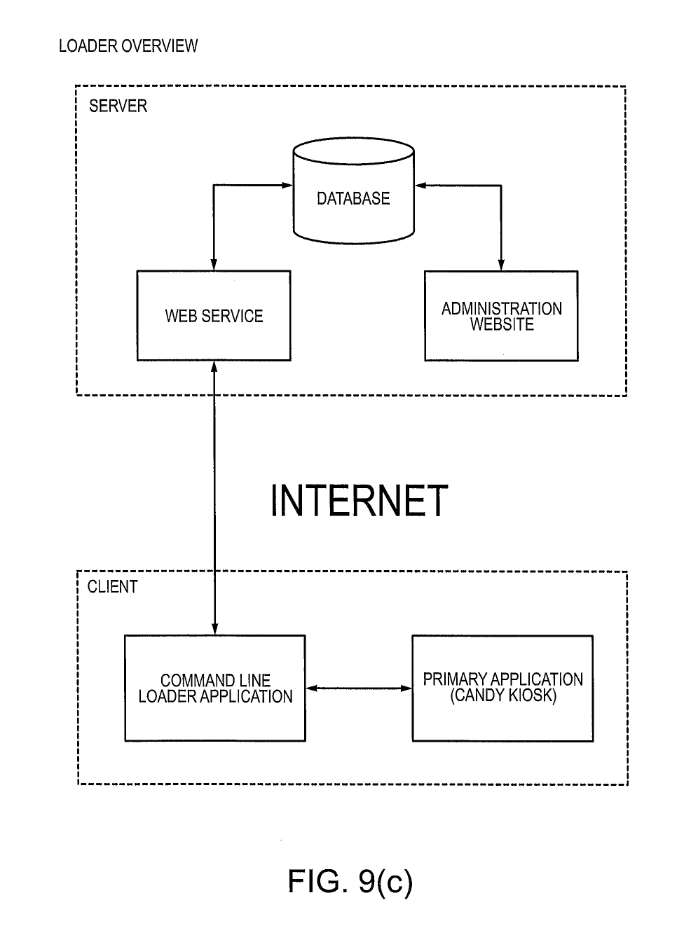

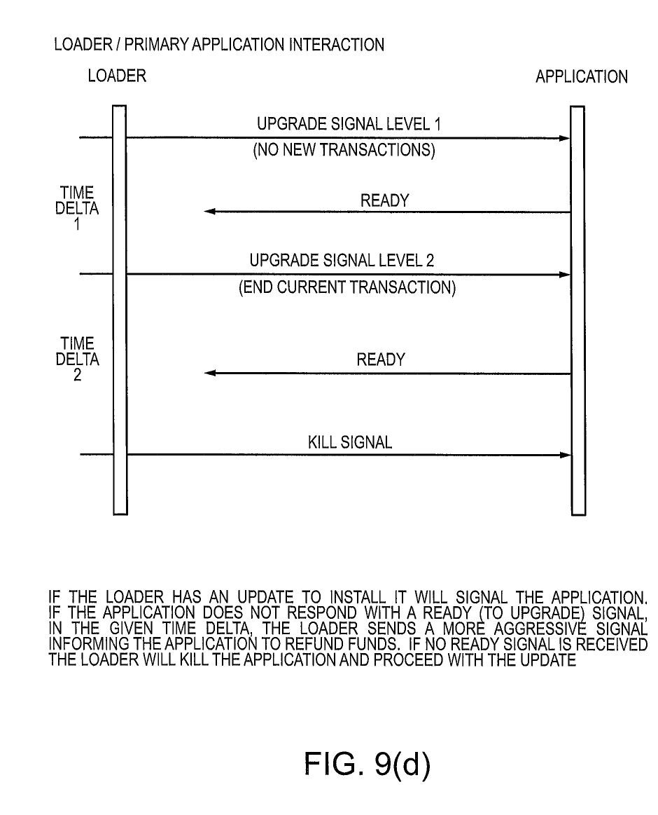

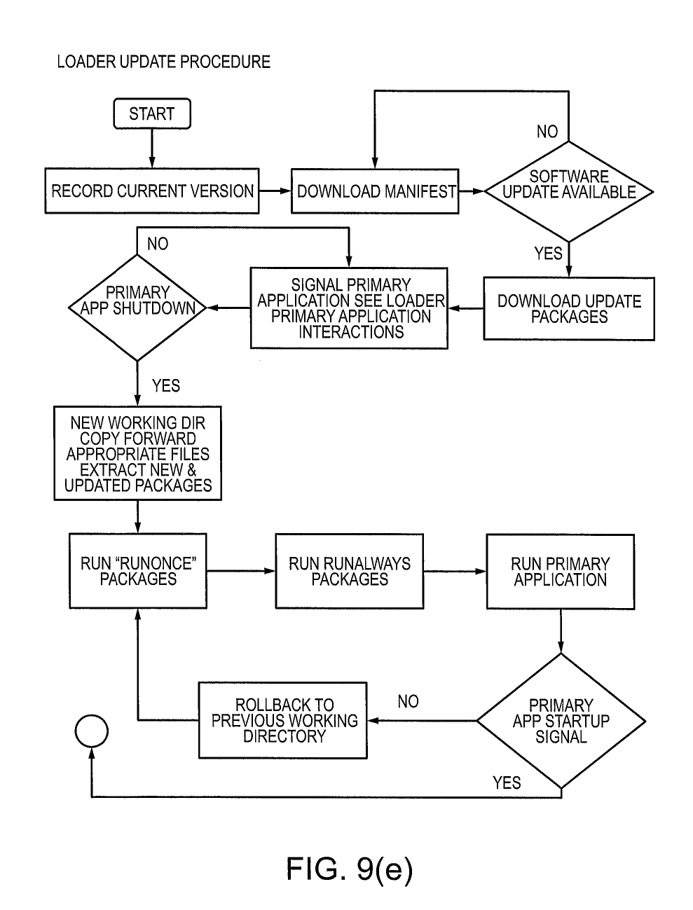

Reference is made to FIGS. 9(a) to 9(e) which illustrate the operation of the software update and loader functions in more detail.

FIG. 9(a) shows in flowchart form, a process 900 comprising steps or operations depicted in individual blocks/steps for remotely deploying software and other updates to one or more kiosks arranged in a network configuration for example as described above.

FIG. 9(b) shows in flowchart form, a process 920 comprising steps or operation depicted in individual blocks/steps for registering a loader client and recording software versions.

FIG. 9(c) shows in block diagram form a system configuration 930 for the loader function or mechanism.

FIG. 9(d) shows signal/data flow between the loader program and the application program according to an embodiment of the invention.

FIG. 9(e) shows in flowchart form, a process 950 comprising steps or operation depicted in individual blocks/steps for updating the loader application.

According to embodiment and as shown in FIG. 14, the control unit 122 comprises the computer 1400 (e.g. a PC based computer platform) and the control board 1410 operatively coupled to the computer. According to an exemplary implementation, the control board 1410 utilizes a MSP430 processor from Texas Instruments as a main processor 1412 on the board. It uses a serial COM port or a virtual USB COM port to communicate to the computer 1400. It will be appreciated that this means that reprogramming the firmware on the chip can be difficult and requires a boot loader that can switch between running programs. If any errors occur during programming in this method the only way to recover a machine is to send the board back to the factory for reprogramming. According to another embodiment, the control board 1410 is configured with a secondary processor 1413, such as the MSP430 processor from Texas Instruments, and the secondary processor 1413 is configured to monitor the COM signal line. The secondary processor 1413 is configured as a “programming chip” or processor and is connected to the low-level flash reset pins of the main MSP430 processor 1412. The programming processor 1413 is configured to listen to the COM lines for a selected signal packet that indicates it should put the main processor 1412 into programming mode. The programming processor 1413 then receives the data from the COM line and programs the main processor 1412 accordingly. Checksums are used for every packet to ensure integrity. If any errors occur then the process can safely be restarted without the need for attaching extra wires or ports to the main chip as would be done in a factory reset. It will be appreciated that the two processor configuration comprises both devices working on the same serial communications lines, i.e. one processor 1412 (i.e. the main MSP430 processor) operates the board and the other processor 1413 (i.e. the second MSP430 processor) sits and listens waiting for a specific byte sequence. Once the correct command comes in, the programming processor 1412 puts the controller processor, i.e. the main processor 1412, into reset mode and prepares it for programming. At this point the programming processor 1413 will take control of the transmit line on the serial port as well.

A process for updating firmware according to an exemplary implementation comprises the following steps/operations:
(1) the programming processor is waiting and monitoring main serial line for special byte sequence and passes along any other commands to the main processor
(2) the programming processor receives special byte sequence and intercepts the byte before it goes to the main processor
(3) the programming processor activates two signal lines to the main chip that put the main chip in programming mode
(4) the programming processor receives a stream of bytes from the computer can contain the new firmware to be placed on the main chip
(5) the programming processor puts each byte of the new firmware in program memory for the main processor
(6) the programming processor checks the written firmware for errors and notifies the computer if there are any errors or code faults
   When all the firmware bytes have been transferred to the main processor correctly, the programming programming lines are released and the main processor returns to normal operating mode with the new firmware update, and the programming processor goes back to waiting for the special byte sequence.

Reference is next made to. FIG. 10, which shows a cup dropper module for the vending machine 100 according to an embodiment of the present invention. The cup dropper module is indicated generally by reference 1000 and comprises a plurality of auger units 1010, indicated individually by references 1010a, 1010b, 1010c and 1010d in FIG. 10. Each of the auger units 1010 comprises an auger 1012, an auger motor 1014 and an auger motor position sensor 1016. Cups are stacked into each of the auger units 1010 and the auger motor 1014 is actuated by the control unit 122 (e.g. via ports on the control board 1410) to drop or release a cup from the respective auger unit 1010. For the configuration depicted in FIG. 10, each of the auger units 1010 can be set up to hold a different size cup or container. The cup dropper module 1000 is configured with a funnel 1020 which is operatively coupled to the bins 142 (FIG. 1), for example, a tube or other type of conduit, that directs product (e.g. candy) released from one of the bins to the funnel 1020. As shown, the funnel 1020 has a lower end 1022 which directs the product into a cup or other container positioned below the funnel 1020. As also shown in FIG. 10, the cup dropper module 1000 is configured with a front face or panel 1030 having an opening 1032 where the cup is positioned below the funnel 1020, and the opening 1032 is configured to align with the opening or access doors 150 on the vending kiosk 100 as shown in FIG. 1.

Referring again to FIG. 10, the cup dropper module 1000 is configured with a conveyer belt 1040 and a conveyer belt drive motor 1042. The conveyer belt 1040 is configured to move a cup dropped from one of the augers 1010 to a position below the candy funnel 1020, i.e. lined up with the lower end 1022 of the funnel 1020 so that the cup can be filled with candy or other product. The conveyer belt drive motor 1042 is operatively coupled and controlled by the control unit 122 (e.g. via ports on the control board 1410). According to an embodiment, a front cup sensor 1044 is positioned in the opening 1032 and configured to detect when a cup has been moved into position by the conveyer belt 1040. In response to the output from the front cup sensor 1044, the control unit stops the conveyer belt 1040 to position the cup under the funnel 1022. If necessary, the control unit can incrementally advance or reverse the conveyer belt 1040 using the conveyer belt drive motor 1042 to re-position the cup.

As shown in FIG. 10, the cup dropper module 1000 is configured with a candy fall sensor indicated generally by reference 1046. The candy fall sensor 1046 is located proximate the lower end. 1022 of the funnel 1020 and operatively coupled to the control unit to monitor the release of candy through the funnel 1020 and into the cup positioned below the funnel 1020. The cup dropper module 1000 is also configured with a cup drop sensor 1048 for each of the augers 1010. The cup drop sensors 1048 are operatively coupled to the control unit and configured to detect/monitor the release of cup from the respective auger 1010 onto the conveyer belt 1040 running inside the cup dropper module 1000.

According to another embodiment, the conveyor belt 1040 is replaced by a bar that is configured to move back and forth along the bottom of the cup dropper module 1000. The bar (not shown) can also function to clean the bottom surface of the module 1000. According to another embodiment, the bottom surface of the cup dropper module 1000 is sloped so that a cup released from one of the augers 1010 slides into position under the funnel 1020.

According to an embodiment, the control unit is configured to operate under stored program control (e.g. software and/or firmware) to perform the following process:
(1) the control unit establishes a baseline sensor reading, e.g. infrared level, using one or more of the cup drop sensors
(2) the control unit checks that the sliding access door for the cup drop opening 150 (FIG. 1) is closed
(3) the control unit actuates the auger motor for one of the auger units to drop or release a cup
(4) the control unit reads the output from the associated cup drop sensor to check for the presence of a cup
(5) if a cup is not present, the control unit runs the auger unit again; if a cup is still not detected, the control unit is configured to use of the other auger units to drop or release a cup
(6) when the control unit detects a cup, the conveyer belt drive motor is activated to start the belt moving forward and move the cup towards the front face of the cup dropper module
(7) the control unit monitors the front cup sensor along the surface of the belt near the funnel area
(8) when the Front Cup Sensors are tripped (there are two sensors for this detection process), the control unit stops the conveyer belt
(9) the control unit actuates the bin with the selected product (e.g. candy) causing product to fall down the flow tube, into the candy funnel which directs the candy into the cup
(10) the control unit checks the candy fall sensor to verify that product fell through the candy funnel
(11) when the candy has finished falling into the cup, the control unit activates a solenoid that unlocks the sliding access door
(12) the customer is then able to open the door and remove the cup with the dispensed product
(13) the control waits for the door to close and activates the lock when closed
(14) the control runs the belt backwards to clear the chamber. If the control unit detects a large object (i.e. using the front cup sensors or the cup drop sensors), such as cup full of candy, on the belt when going backwards, the control unit moves the conveyer belt in the forward direction to bring the cup back to front access door and to give the customer another opportunity to remove the cup by unlocking the door
(15) if after a timeout period, the object is not removed, the control unit locks the door and runs the belt backwards to transfer the transfer the object to a waste chute or container

As described above, the cup dropper module 1000 is configured with a conveyor belt 1020 and conveyer belt drive motor 1022. The conveyor belt 1020 allows the cups to be effectively brought forward to the funnel area; allows multiple augers (i.e. cup columns) to be used to maximize cup capacity or cup sizes; allows for any cups that have errors when dropped to be cleared out the back into the garbage area by running the conveyer belt drive motor in reverse; allows for any spilled candy to be cleared using the same method; allows for any external objects placed in the cup dropper to be cleared as well.

According to another embodiment, the conveyor belt drive motor 1022 is coupled to a belt mechanism roller. The belt mechanism roller comprises a sprocket socket on one side and a half moon key socket on the other. The belt mechanism roller is configured to tighten the conveyor belt 1020 is as follows:
(1) plastic piece sandwiches an L-bracket to the side of the cup dropper frame via two bolts. This bracket is able to slide back and forth.
(2) a tightening screw puts pressure against the L-bracket which tightens the belt
(3) the screw is adjusted to the appropriate pressure and then the two bolts are tightened, holding the roller securely in place

As described above, the control unit utilizes sensors to determine the position of the auger motors running the cup augers and the motors for actuating the bin scoops in the bins. According to an embodiment, the motors including an attached wheel with one or more magnets inserted. According to an exemplary implementation, a Hall Effect type sensor is used to determine the “home” position of the motor and return the motor to this position after every operation.

According to another aspect, the control unit 122 (e.g. via ports on the control board 1410) utilizes the cup drop sensors 1048 (FIG. 10) to determine and/or verify that a cup has been released or dropped from the associated auger unit 1010 (FIG. 10). The control unit also utilizes the front cup sensors 1044 (FIG. 10), i.e. two sensors to determine that the cup has been moved to the appropriate place under the funnel 1020. The control unit utilizes the candy fall sensor(s) 1046 (FIG. 10) to verify that product has been dispensed down the funnel 1020.

According to another embodiment, a plurality of sensors (e.g. infrared sensors) are placed proximate to the surface of the conveyor belt 1040. The control unit 122 is configured (i.e. through firmware and/or software) to determine potential obstructions (and the height of the potential obstructions) on the conveyor belt 1040. If a low sensor is tripped but not a high sensor while the belt is moving, then control unit determines that the object on the belt is small and most likely a piece of candy. A higher obstruction will block both sensors. The control unit is configured to use this information to determine whether an object should be returned to the funnel area or simply discarded. According to another aspect, the control unit is configured to utilize two sensors to approximate the speed of the cup on the belt. This value is used to calculate how much longer the belt should be run until the cup is in the ideal position.

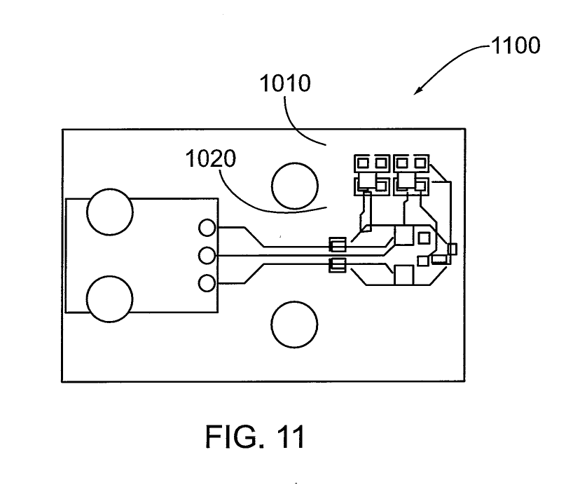

Reference is next made to FIG. 11, which shows a sensor board according to an embodiment of the present invention and indicated generally by reference 1100. It will be appreciated that the cups can comprise clear cups and this can make the detection more difficult using infrared sensors. According to an embodiment, the sensor board 1100 is configured to utilize the relative thickness of the plastic on the cup as it appears to the sensor when the cup first breaks the sensor beam to accurately detect the presence of a cup. This is also used to detect the removal of a cup. The sensor board 1100 comprises a multifunction configuration and can be populated with infrared emitter(s) 1110 and infrared detector(s) 1120 or Hall Effect type sensors. According to an embodiment, the infrared emitter(s) and infrared detector(s) are configured on one side of the sensor board. The sensor board 1100 can be configured as an infrared emitter board or as infrared sensor board. For Hall Effect, i.e. magnetic sensing, the sensor board 1100 is populated with Hall Effect sensors according to PCB tracks laid out on the other side of the sensor board 1100. According to another aspect, the sensor board 1100 is configured with a connector having a common pin layout. The sensor board 1100 generates an analog output that is converter by an analog-to-digital (A/D) converter to a digital signal for further processing by the control unit. According to an exemplary implementation, the control unit is configured to take a first base line reading and determine if the reading is a defined range. If not, then it is assumed that there is something blocking the infrared source such as a cup or even a heavy coating of dust. If the baseline reading is within a defined range, the object will cause a trip at a value set in the software or firmware executed by the control unit. According to an exemplary implementation, the Hall Effect type sensor comprises an on/off digital device where the sensor has a built in hysteresis. Different types of sensors with the same footprint can be installed on the sensor board 1100 depending on the functionality as will be within the understanding of one skilled in the art. For instance, Hall Effect devices are available that will switch in the presence of any magnetic field. There are also Hall Effect devices that switch in the presence or a north of south field and other devices that switch when there is a polarity change.

According to another embodiment, one or more of the sensors are implemented utilizing an image capture system, which takes a picture of an operational area, for example, the conveyer belt area, and then the image is analyzed to determine the position and/or orientation of the cup. According to another embodiment, sensors are utilized that determine the cup position by static electricity. The vending kiosk includes other types of sensors for detecting temperature, humidity, and intrusion.

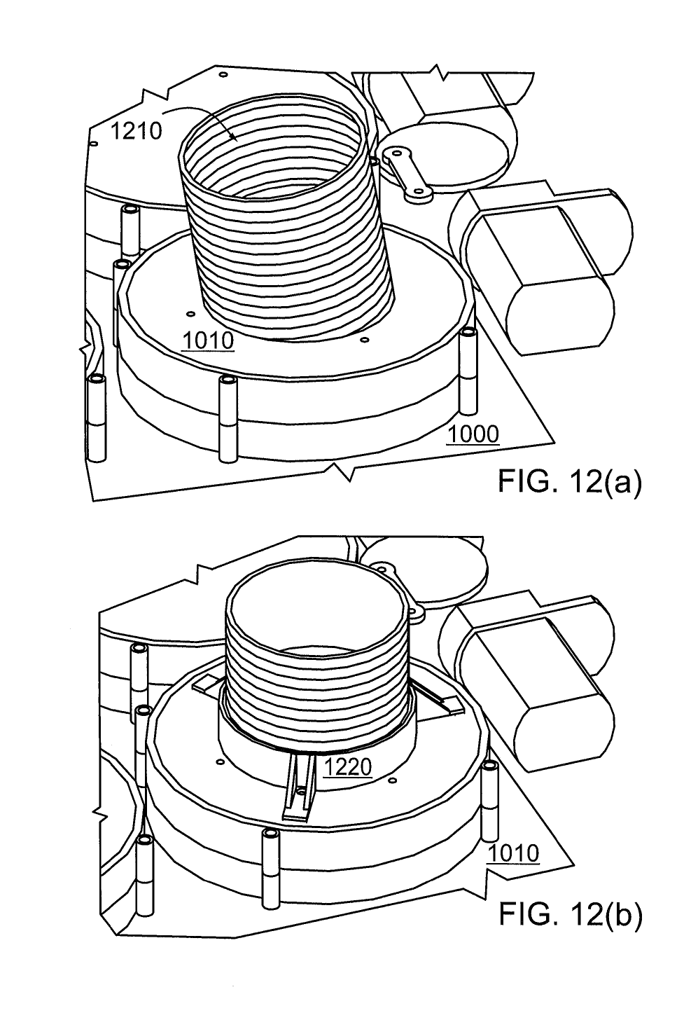

Reference is next made to FIGS. 12(a) and 12(b). FIG. 12(a) shows a stack of cups 1210 that are misaligned in the auger unit 1010 for the cup dropper module 1000. Actuation of the auger unit 1010 by the control unit would not properly release the cup or further jam the auger unit 1010. According to an embodiment, the auger unit 1010 is configured with a guide ring as shown in FIG. 12(b) and indicated generally by reference 1220, which functions to orient the cup stack 1210 substantially in line with the feed direction of the auger unit 1010. This facilitates the feeding of the cup stack 1210 into the auger unit 1010 and the release of individual cups onto the conveyer belt as described above.

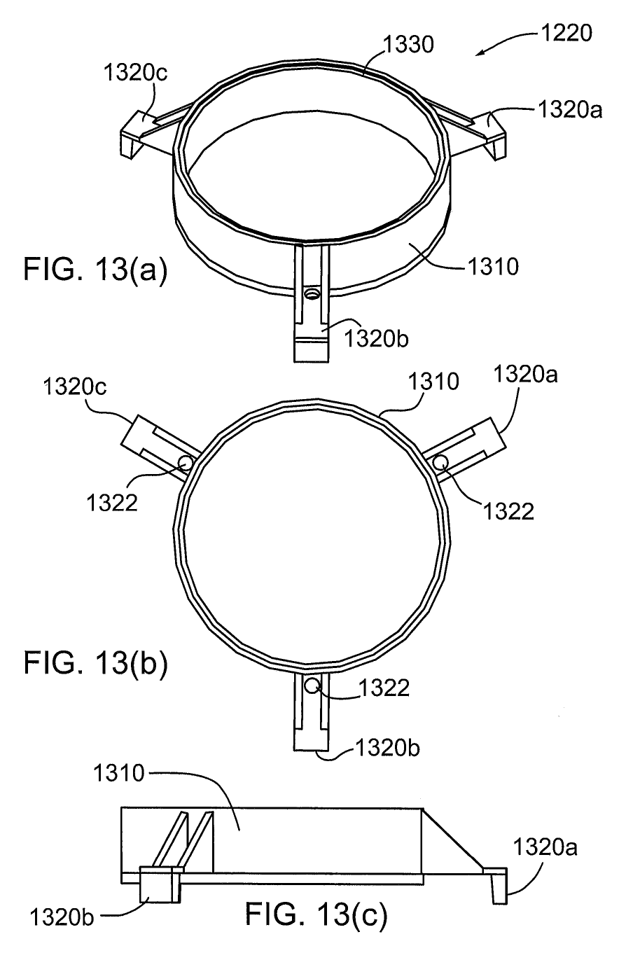

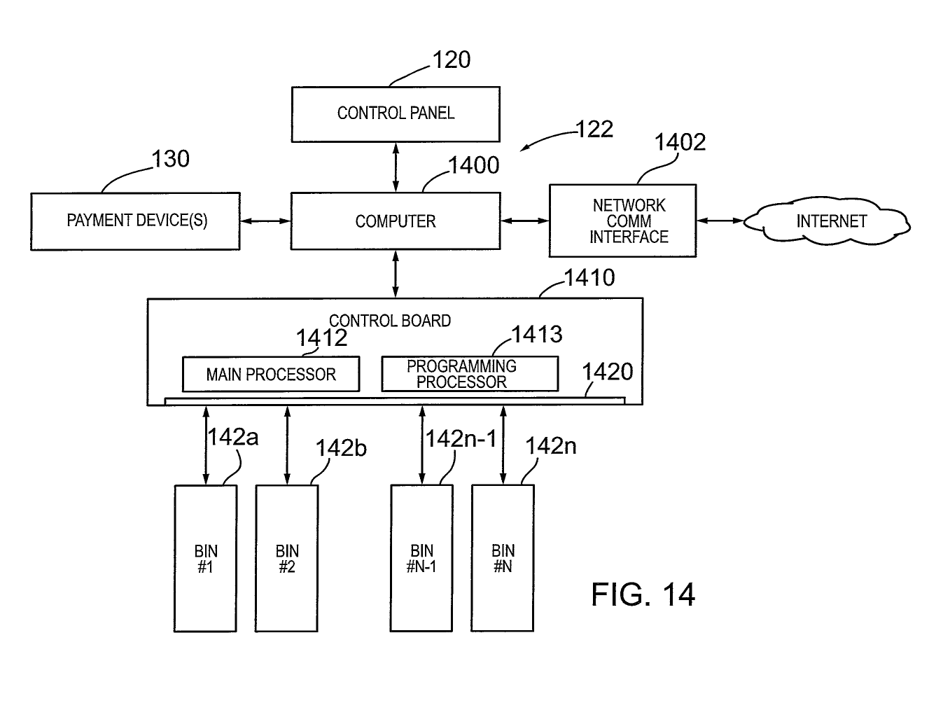

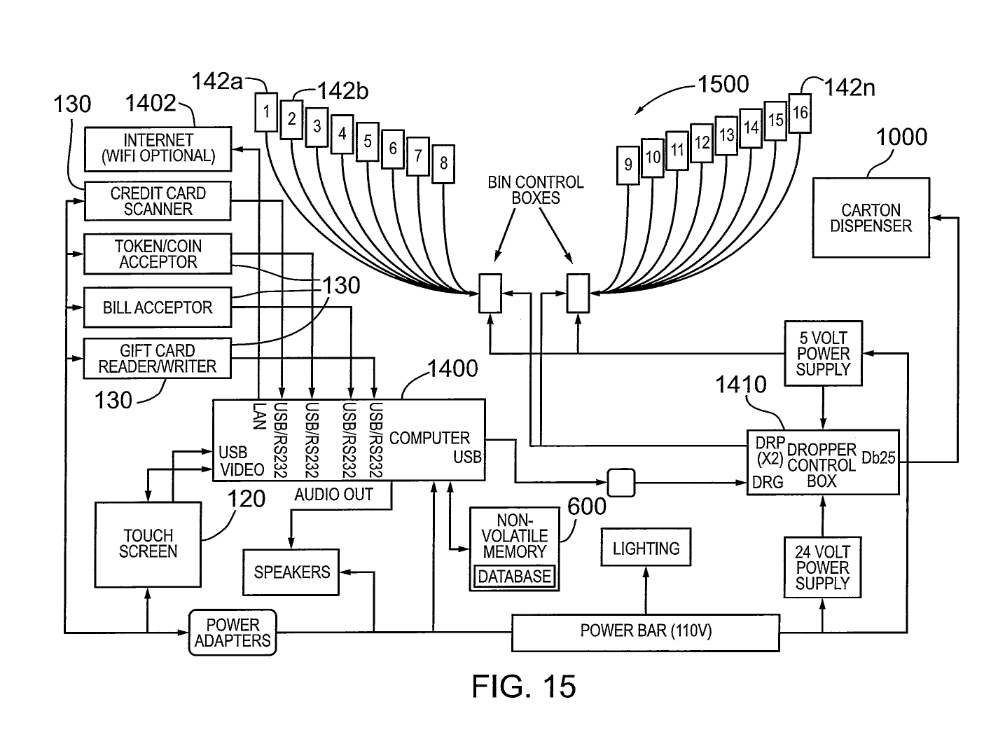

Reference is next made to FIGS. 13(a) to 13(c) which show the guide ring configuration 1220 in further detail. The guide ring 1220 comprises a ring component 1310 and a plurality of mounting tabs 1320, as shown. According to an exemplary implementation, the guide ring 1220 is fabricated as a single piece, for example, as an injection molded component. The ring component 1310 is approximately 2″ high and there are three mounting tabs, indicated by references 1320a, 1320b and 1320c, each with a hole or aperture 1322 for receiving a suitable fastener to secure the guide ring 1220 to an upper face or mounting surface of the auger unit 1010. According to another embodiment, the mounting tabs 1320 comprise a clip mechanism to secure the guide ring 1220 to the auger unit 1010 without the need for bolts.

As shown in FIG. 12(b), the outside diameter of the guide ring 1220 allows the device to align tightly with the opening of the auger mechanism. The inside diameter of the ring component 1310 (FIG. 13(b)) is fitted to the diameter of the cup being dispensed, for example, a PKS16C model cup from FabriKal, and can be adapted for any other type or size cup. As shown in FIG. 13(a), the ring 1310 includes a beveled top edge 1330. The bevel edge 1330 slopes towards the inside of the ring and functions to prevent any rims of the cup stack from getting caught up on the edge of the ring 1310.

According to an embodiment, the control unit 122 is configured with a process (i.e. operating under stored program control, software and/or firmware) to perform a process for unjamming a cup by changing the direction of the motor and varying the applied voltage. The process comprises the following steps:
Step 1: the auger (i.e. cup) motors 1014 (FIG. 10) are typically operated with a low voltage (according to an exemplary implementation at 5V) to manage the speed of the dispenser
Step 2: if a jam is encountered (high current), the voltage is raised (for example, 12V) to overcome the jam for a predetermined amount of time (for example, 250 mS)
Step 3: when the voltage is lowered to normal levels, if the current is within the normal range the jam has been overcome and cup should dispense
Step 4: if the current is still high, the control unit repeats Step 2 for a total of 3 attempts. If high current is encountered at high voltage, the control unit changes the direction and the operation is attempted running the motor in reverse for a total of 2 attempts. If after all this there is still a jam at high voltage, the control unit generates an error condition.

Reference is next made to FIG. 15, which shows in block diagram a system configuration for the vending kiosk of FIG. 1 and according to an exemplary implementation indicated generally by reference 1500.

The present invention may be embodied in other specific forms without departing from the spirit or essential characteristics thereof. Certain adaptations and modifications will be obvious to those skilled in the art. Therefore, the presently discussed embodiments are considered to be illustrative and not restrictive.

What is claimed is:

1. A system for dispensing a bulk product, said system comprising:
one or more bins, each for holding a bulk product;
a control panel for receiving a user request for one of said bulk products;
a computer operatively coupled to said control panel and a control board operatively coupled to said computer;
said control board being operatively coupled to said computer and being configured to be responsive to control commands;
said control board being operatively coupled to said one or more bins, and responsive to said control commands for controlling a dispensing component coupled to each of said one or bins to dispense the requested bulk product from the associated bin in an amount based on said user request.

2. The system as claimed in claim 1, wherein said dispensing component comprises a bin scoop and an actuator coupled to said bin scoop and configured for operating said bin scoop in a dispensing mode in response to one or more control signals from said control board.

3. The system as claimed in claim 1, wherein said one or more bins are configured with a bin throat component, said bin throat component being affixed in said bin and configured proximate to said bin scoop for directing a portion of the bulk product into said bin scoop.

4. The system as claimed in claim 1, wherein control board comprises a primary processor and a secondary processor, said primary processor being configured to be responsive to said control commands and said secondary processor being configured to be responsive to a program update command and in responsive to said program update configuring said primary processor in a temporary program update state.

5. A method for dispensing bulk products from one or more bins, said method comprising the steps of:
receiving a bulk product selection from a user;
receiving a bulk product dispensing amount from the user;
enabling the bin containing the selected bulk product; and
dispensing the selected bulk product from the enabled bin in the amount specified by the user.

6. A cup dropper module for a vending kiosk comprising a plurality of bins and each of the bins holding a product, said cup dropper module comprising:
a plurality of auger units, each of said auger units being configured to hold a plurality of cups;
an auger motor operatively coupled to each of said auger units and configured to actuate said auger unit to individually release said plurality of cups;
a funnel said funnel being operatively connected to the plurality of bins and configured to receive a product from each the plurality of bins, and said funnel including a downspout configured for directing said received product into one of said cups;
a conveyor operatively coupled to a conveyer drive motor for moving said released cup to said downspout of said funnel; and
said conveyer drive motor and said auger motors being operatively coupled to a controller and responsive to control signals for actuation.

7. The cup dropper module as claimed in claim 6, further including an auger motor position sensor for each of said auger motors and configured to generate an output for said controller indicative of the position of said auger motor.

8. The cup dropper module as claimed in claim 6, further including a cup drop sensor, said cup drop sensor being positioned proximate said auger unit and configured to generate an output for said controller corresponding to detection of said released cup.

9. The cup dropper module as claimed in claimed 8, further including a product sensor positioned proximate said funnel and configured to generate an output for said controller corresponding to detection of product passing through said funnel.

10. The cup dropper module as claimed in claim 6, wherein one or more of said auger units include a ring configured to align said plurality of cups in a substantially vertical stack.

11. A computer readable memory for storing data and information for access by an application program being executed on a computer, said data and information being associated with a vending kiosk configured for dispensing bulk products stored in a plurality of bins in response to a customer request, said computer readable memory comprising:
data structure configured in the computer readable memory for storing data associated with a system configuration for the vending kiosk; and
a data structure configured in the computer readable memory for storing data associated with a vending session for the vending kiosk.

12. The computer readable memory as claimed in claim 11, wherein said system configuration data structure further comprises a link to one or more of a language data structure configured for storing language data, a version data structure configured for storage system version data, a bins data structure configured for storing bin data, a cup data structure configured for storing cup data, and a cup image data structure configured for storing cup images.

13. The computer readable memory as claimed in claim 11, wherein said vending session data structure further comprises a link to, one or more of a language selection data structure configured for storing selected language data, a cup selection data structure configured for storing selected cup data, a scoop data structure configured for storing bin scoop information, a sign-up data structure configured for storing sign up information and a camera demographics data structure configured for storing camera information.

14. The computer readable memory as claimed in claim 11, wherein said vending session data structure further comprises a link to an attempted transaction data structure configured with links to one or more of a cash preferred data structure, a cash payment data structure, a gift card data structure, a credit card data structure and a promotional code payment data structure.

14. A mechanism for monitoring the operation of a vending kiosk based on the operation of one or more subsystems associated with the vending kiosk, said mechanism comprising:
an interface for receiving a request from an external source;
means for processing said request and selecting one of the subsystems based on said request;
means for querying said selected subsystem;
means for receiving data from the queried subsystem and transmitting said data to said external source.

15. The mechanism as claimed in claim 14, wherein said mechanism comprises an application program interface comprising a plurality of executable computer instructions stored on a computer readable media.

16. The mechanism as claimed in claim 15 wherein said subsystem comprises one or more local databases associated with the operation of the vending kiosk.

17. The mechanism as claimed in claim 15, wherein said subsystem comprises a user interface program configured to operate on the vending kiosk.

18. The mechanism as claimed in claim 15, wherein said subsystem comprises an operating system configured for the vending kiosk.

19. A bin for dispensing a bulk product in a vending machine, said bin comprising:
a storage volume for storing the bulk product;
a lid for enclosing said storage volume;
an opening for releasing said bulk product from said storage volume;
a bin scoop configured adjacent said opening, and operatively coupled to an actuator to dispense a portion of said bulk product through said opening.

20. The bin as claimed in claim 19, wherein said bin scoop includes one or more agitation arms, said agitation arms being responsive to movement of said bin scoop for agitating bulk product inside said storage volume.

21. The bin as claimed in claim 20, further including a bin throat positioned adjacent said bin scoop and being configured with an opening for directing bulk product from said storage volume into said bin scoop.

22. The bin as claimed in claim 21, wherein said bin throat includes a guide for each of said one or more agitation arms.
